(19) United States
(12) Patent Application Publication
(10) Pub. No.: US 2008/0040064 A1
(43) Pub. Date: Feb. 14, 2008

(54) SURFACE INSPECTION APPARATUS AND SURFACE INSPECTION METHOD

(76) Inventor: Akio Ishikawa, Hachioji-shi (JP)

Correspondence Address: CHRISTIE, PARKER & HALE, LLP, PO BOX 7068, PASADENA, CA, 91109-7068, US

(21) Appl. No.: 11/835,362

(22) Filed: Aug. 7, 2007

(30) Foreign Application Priority Data
Aug. 10, 2006 (JP) 2006-218399

(51) Int. Cl. G06F 19/00

(52) U.S. Cl. 702/108

(57) ABSTRACT

A surface inspection apparatus (1) for detecting a defect on a surface of a sample 2 by inspecting an image captured of the surface of the sample 2 under a prescribed optical condition, comprises: a defect detection unit 24 for detecting a defect appearing in the captured image by using a prescribed detection condition, and an inspection condition determining unit 50 for setting at least one of the prescribed optical condition and the prescribed detection condition to a condition under which a known standard defect 9 formed in advance on an inspection surface of the sample 2 to be inspected can be detected using the defect detection unit 24.

### CROSS REFERENCE TO RELATED APPLICATION

This application is based upon and claims the benefit of priority from the prior Japanese Patent Application No. 2006-218399, filed on Aug. 10, 2006, the entire contents of which are incorporated herein by reference.

### BACKGROUND OF THE INVENTION

1. Field of the Invention

The present invention relates to a surface inspection apparatus and surface inspection method for detecting a defect on the surface of a sample under inspection by inspecting an image captured of the surface of the sample. More particularly, the invention relates to a surface inspection apparatus and surface inspection method for detecting a defect in a pattern formed on the surface of a sample such as a semiconductor wafer, a photomask substrate, a liquid crystal display panel substrate, or a liquid crystal device substrate, based on an image captured of the surface of the sample. Even more particularly, the invention relates to a technique for determining inspection conditions to be used in such a surface inspection apparatus and surface inspection method, such as a detection condition to be used when detecting a defect from the captured image and an optical condition under which the image is captured.

2. Description of the Related Art

The manufacturing process of a semiconductor device, such as a semiconductor wafer, a photomask substrate, a liquid crystal display panel, or the like, comprises many processing steps, and it is important from the standpoint of improving manufacturing yields to inspect the occurrence of defects at intermediate steps as well as at the final step and to feed back the results to the manufacturing process. To detect defects during the manufacturing process, surface inspection such as pattern defect inspection is widely practiced which captures an image of a pattern formed on the surface of a sample such as a semiconductor wafer, a photomask substrate, a liquid crystal display panel substrate, or a liquid crystal device substrate, and detects any defects existing on the surface of the sample by inspecting the captured image.

The following description will be given by taking as an example a semiconductor wafer surface inspection apparatus for inspecting patterns formed on a semiconductor wafer for defects. However, the present invention is not limited to this particular type of apparatus, but can be widely applied to surface inspection apparatus for inspecting semiconductor devices such as semiconductor memory photomask substrates, liquid crystal device substrates, liquid crystal display panel substrates, and the like.

FIG. 1 shows a block diagram of a surface inspection apparatus similar to the one that the applicant of this patent application proposed in Japanese Patent Application No. 2003-188209. Generally, the surface inspection apparatus 1 comprises a microscope unit 10 for capturing an image of a semiconductor wafer 2 (hereinafter simply called the “wafer 2”) and an image processing unit 20 for detecting a defect existing on the surface of the wafer 2 by inspecting the captured image.

The microscope unit 10 is provided with a stage 11 which is movable in two-dimensional directions, and a sample holder (chuck stage) 12 is mounted on the upper surface of the stage 11. The wafer 2 as a sample to be inspected is placed on the sample holder 12 and held fixed thereon. The stage 11 moves in two-dimensional directions, i.e., in the X and Y directions, under the control of a control signal supplied from a stage control unit 18. Further, by moving the sample holder 12 up and down along the Z direction, the wafer 2 can be moved in three-dimensional directions.

The microscope unit 10 includes an objective lens 13 through which an optical image of the surface of the wafer 2 is projected, and an image capturing unit 14 which captures the optical image of the surface of the wafer 2 projected through the objective lens 13. The image capturing unit 14 is constructed from an image sensor such as a one-dimensional or two-dimensional CCD camera, preferably a TDI camera, and converts the optical image of the surface of the wafer 2 focused on its light receiving surface into an electrical signal.

In the illustrated example, the image capturing unit 14 is constructed from a one-dimensional TDI camera. Here, the stage control unit 18 causes the stage 11 and hence the wafer 2 to move relative to the image capturing unit 14 so that the image capturing unit 14 scans the wafer 2 in the X or Y direction and captures a two-dimensional image of the surface of the wafer 2.

The microscope unit 10 further includes a light source 15 and light-gathering lens 16 for illuminating the wafer 2, and a half-silvered mirror (beam splitter) 17 placed in the projection light path of the objective lens 13. The illuminating light gathered by the light-gathering lens 16 is reflected by the half-silvered mirror 17 toward the objective lens 13, while the optical image of the surface of the wafer 2 that the objective lens 13 projects toward the light receiving surface of the image capturing unit 14 is allowed to pass through the half-silvered mirror 7.

Such illumination provides bright-field illumination light for illuminating the surface of the wafer 2 from the vertical direction containing the optical axis of the objective lens 13, and the image capturing unit 14 captures the image of the light specularly reflected at the thus illuminated wafer 2.

For simplicity of explanation, the following description will be given by taking as an example a surface inspection apparatus equipped with a bright-field illumination optical system, but the present invention is not limited to this type of optical system. Some surface inspection apparatus employ a dark-field optical system which does not directly capture the illumination light, and the present invention is also applicable to a surface inspection apparatus equipped with such a dark-field optical system. In the case of dark-field illumination, the wafer is illuminated from an oblique or a vertical direction, and a sensor is disposed so as not to detect specularly reflected light. Then, the dark-field image of the surface of the object is obtained by sequentially scanning the surface with the illumination light. Accordingly, certain types of dark-field apparatus may not use image sensors, but it will be appreciated that such types of apparatus also fall within the scope of the present invention.

The image signal output from the image capturing unit 14 is converted into a multi-valued digital signal (gray level signal), which is then stored in a signal storing unit 21 in the image processing unit 20.

As shown in FIG. 2, a plurality of dies (chips) 3 are formed on the wafer 2 in a matrix pattern in repeated fashion in the X and Y directions. Since the same pattern is formed on each die, the images captured of these dies should be identical to each other, and the pixel values of corresponding portions in the captured images should also be the same.

Accordingly, by detecting a pixel value difference (gray level difference signal) between corresponding portions in the captured images of any two dies that should normally be identical to each other, the presence or absence of a defect in any one of the dies can be detected, because the gray level difference signal becomes greater when there is a defect in either one of the dies than when there is no defect in either die (die-to-die comparison).

On the other hand, when repeated patterns, such as memory cells, are formed within each die, the presence or absence of a defect can also be detected by detecting a gray level difference between the images captured from the corresponding portions of the repeated patterns that should normally be identical to each other (cell-to-cell comparison).

In a die-to-die comparison, it is general practice to compare the images captured of two adjacent dies (single detection). However, in this case, it is not possible to which die contains the detected defect. Therefore, the die is further compared with a die adjacent on a different side, and if the gray level difference in the same portion is larger than a threshold value, then it is determined that the die under inspection contains the defect (double detection). The same applies to the cell-to-cell comparison.

Turning back to FIG. 1, the image processing unit 20 includes a difference detection unit 22 for calculating the gray level difference between corresponding portions in the images captured of any two dies within the image of the wafer 2 stored in the signal storing unit 21.

As the image capturing unit 14 moves relative to scan the wafer 2 under the control of the stage control unit 18, output signals from the image capturing unit 14 which is a one-dimensional TDI camera are sequentially captured, and the two-dimensional image of the wafer 2 is stored in the signal storing unit 21.

In the die-to-die comparison, the difference detection unit 22 retrieves from the signal storing unit 21 sub-images representing corresponding portions of a plurality of adjacent dies based on the position information of the stage 11 supplied from the stage control unit 18, and takes one of the sub-images as an inspection image and the other as a reference image. Then, a signal representing the gray level difference between the corresponding pixels in the inspection and reference images is computed, and the result is supplied to a detection threshold value calculation unit 23 and a defect detection unit 24.

In the cell-to-cell comparison, the difference detection unit 22 likewise retrieves sub-images representing corresponding portions of a plurality of adjacent cells from the signal storing unit 21, takes one of the sub-images as an inspection image and the other as a reference image, and computes the gray level difference between them.

The detection threshold value calculation unit 23 determines the detection threshold value based on the distribution of the gray level differences detected by the difference detection unit 22, and supplies it to the defect detection unit 24.

The defect detection unit 24 detects the presence or absence of a defect in the inspection image by comparing the gray level difference supplied from the difference detection unit 22 with the detection threshold value determined by the detection threshold value calculation unit 23. More specifically, when the gray level difference signal exceeds the detection threshold value, the defect detection unit 24 determines that the inspection image contains a defect at the position of the pixel for which the gray level difference signal was computed.

Then, for each detected defect, the defect detection unit 24 creates and outputs defect information which includes such information as the position and size of the detected defect, the gray level difference between the inspection image and the reference image, and the gray level values of these images.

FIG. 3 is a block diagram showing a configuration example of the detection threshold value calculation unit 23.

As shown, the detection threshold value calculation unit 23 comprises a cumulative frequency computing unit 31 which takes as an input the gray level difference output from the difference detection unit 22 and computes its cumulative frequency, a converted cumulative frequency computing unit 32 which takes the cumulative frequency as an input and computes a converted cumulative frequency by converting the cumulative frequency so that the cumulative frequency show a linear relationship to the gray level difference, an approximation straight line computing unit 33 which computes an approximation straight line by approximating the entirety of the converted cumulative frequency by a straight line, and a threshold value determining unit 34 which, based on the approximation straight line, determines the threshold value based on a prescribed cumulative frequency value in accordance with a prescribed calculation method.

The operation of the thus configured detection threshold value calculation unit 23 and its component elements will be described with reference to FIGS. 4A to 4C. FIGS. 4A to 4C are diagrams for explaining how the detection threshold value is calculated by the detection threshold value calculation unit 23 shown in FIG. 3.

The gray level difference calculated pixel by pixel by the difference detection unit 22 in FIG. 1 is input to the cumulative frequency computing unit 31 in FIG. 3. The cumulative frequency computing unit 31 constructs a histogram, such as depicted in FIG. 4A, that shows the distribution of the gray level differences calculated for all the pixels contained in the inspection image and reference image. Here, if the number of pixels to be inspected is large, the histogram need not be constructed by using the gray level differences of all the pixels, but can be constructed by using the gray level differences only of selectively sampled pixels.

Then, the cumulative frequency computing unit 31 computes the cumulative frequency of the gray level difference from the histogram.

Next, assuming that the gray level difference input to the detection threshold value calculation unit 23 obeys a certain type of distribution, the converted cumulative frequency computing unit 32 converts the cumulative frequency calculated by the cumulative frequency computing unit 31 so that the cumulative frequency shows a linear relationship to the gray level difference. Here, the converted cumulative frequency computing unit 32 converts the cumulative frequency by assuming that the gray level difference obeys a certain type of distribution such as a normal distribution, a Poisson distribution, or a chi-squared distribution. The thus converted cumulative frequency is shown in FIG. 4B.

Then, from the cumulative frequency thus converted by the converted cumulative frequency deriving unit 32, the approximation straight line deriving unit 33 derives the approximation straight line (y=ax+b) representing the relationship between the gray level difference and the converted cumulative frequency (see FIG. 4C).

The threshold value determining unit 34 determines the threshold value based on the parameters “a” and “b” of the approximation straight line and on sensitivity setting parameters (fixed values). Here, VOP and HO are set as the fixed sensitivity setting parameters for the approximation straight line representing the relationship between the gray level difference and the converted cumulative frequency, and the point on the straight line is obtained that represents the cumulative frequency P1 corresponding to a certain cumulative probability (p) (P1 is obtained by multiplying p by the number of samples). Then, the gray level difference obtained by moving that point by VOP in the vertical axis direction and by HO in the horizontal axis direction is taken as the threshold value.

Accordingly, the threshold value T is calculated by the following equation.

T=(P1−b+VOP)/(a+HO) (1)

In this way, the threshold value can be appropriately determined in accordance with the histogram of the gray level differences of the image under inspection.

With decreasing circuit pattern sizes for semiconductor devices in recent years, there has developed a need for enhancing the defect detection sensitivity of surface inspection apparatus so as to be able to accurately detect microscopic defects.

The defect detection sensitivity of surface inspection apparatus depends on the inspection conditions used in the surface inspection apparatus, such as optical conditions (for example, the intensity of illumination light, the focus position of a focusing optical system, etc.) for an optical system such as the microscope unit 10 and defect detection conditions (for example, the detection threshold used for the detection of a defect, etc.) for the defect detection unit 24.

If inspection is performed without properly setting the inspection conditions, defects that can normally be detected by the surface inspection apparatus may go undetected. In this case, it is not possible to know whether the reason for non-detection is because there were really no defects on the sample or because the inspection conditions were not set properly.

However, in the prior art, it is standard practice to check the apparatus conditions at regular intervals, for example, once a day before inspection, by performing surface inspection using the same dummy wafer every time and by verifying that the apparatus conditions are the same as those when they were checked last time. This is because if all adjustable parts were checked at frequent intervals, the whole task would become extremely laborious, requiring checking a large number of parts that would affect the detection sensitivity of the surface inspection apparatus.

However, the inspection conditions used in the surface inspection differ depending on the wafer to be inspected. An example of the inspection conditions that differ include the wavelength of the light used as the illumination light and the layer to be inspected. In the prior art, therefore, surface inspection was performed without knowing whether the inspection conditions, such as the optical conditions and detection conditions, that have been set by using the dummy wafer before the inspection are appropriate ones for the individual wafer to be inspected.

### SUMMARY OF THE INVENTION

In view of the above problem, it is an object of the present invention to provide a surface inspection apparatus and surface inspection method that can set inspection conditions appropriate to the actual sample to be inspected.

To achieve the above object, in the present invention, a known defect is formed in advance on the actual sample to be inspected, and the inspection conditions to be used for the surface inspection of this sample are set so as to be able to detect this known defect. The known defect thus formed on the actual sample to be inspected will be referred to as the “standard defect.”

More specifically, by setting the inspection conditions for the surface inspection so as to be able to detect the standard defect formed on the actual sample to be inspected, and by performing the surface inspection of the sample using the thus set inspection conditions, it can be ensured that the inspection can be performed with a detection sensitivity that can at least detect the standard defect.

According to a first aspect of the present invention, there is provided a surface inspection apparatus for detecting a defect on a surface of a sample by inspecting an image captured of the surface of the sample under a prescribed optical condition, comprising: a defect detection unit for detecting a defect appearing in the image by using a prescribed detection condition; and an inspection condition determining unit for setting at least one of the prescribed optical condition and the prescribed detection condition to a condition under which a known standard defect formed in advance on an inspection surface of the sample to be inspected can be detected by the defect detection unit.

The inspection condition determining unit may determine as the prescribed optical condition the amount of illumination light with which the surface of the sample is to be illuminated when capturing the image of the surface of the sample or the focusing condition of an image capturing optical system for capturing the image of the surface of the sample.

In one preferred mode of the invention, the defect detection unit may be configured so that when, in the image captured of the surface of the sample, a gray level difference detected between corresponding portions that should normally be identical to each other satisfies the prescribed detection condition, the corresponding portions are detected as defect candidates.

In this case, the inspection condition determining unit is configured to set at least one of the prescribed optical condition and the prescribed detection condition to a condition such that, in the image captured of the surface of the sample under the prescribed optical condition and with the standard defect formed thereon, a gray level difference occurring between a portion containing the standard defect and a portion corresponding thereto (hereinafter referred to as the “standard defect gray level difference”) can satisfy the prescribed detection condition.

By determining at least one of the prescribed optical condition and the prescribed detection condition as described above, and by performing the surface inspection under the thus determined condition, any defects comparable in size to the standard defect can be detected without fail.

In another preferred mode of the invention, the defect detection unit may be configured so that when, in the image captured of the surface of the sample, a comparison result obtained as a result of a comparison between corresponding portions that should normally be identical to each other satisfies the prescribed detection condition, the corresponding portions are detected as defect candidates, and prescribed defect information is output for each of the detected defect candidates. In this case, the prescribed defect information may contain a prescribed evaluation value indicating the result of the comparison made between the corresponding portions, the evaluation value being such that by comparing the evaluation value with a predetermined threshold value, it can be determined whether each of the corresponding portions is a defect candidate or not. This evaluation value may represent the gray level difference between the corresponding portions.

In this case, the inspection condition determining unit is configured to determine at least one of the prescribed optical condition and the prescribed detection condition based on the prescribed evaluation value in accordance with a prescribed determination method.

By obtaining the evaluation value for the standard defect, it becomes possible to know the evaluation value that could arise from a portion containing a defect comparable in size to the standard defect.

Then, at least one of the prescribed optical condition and the prescribed detection condition is determined in accordance with a prescribed determination method. For example, the detection condition is determined so that the detection threshold value becomes smaller than the thus obtained evaluation value, or the optical condition is determined so that, in reference to the currently obtained evaluation value, the evaluation value obtained from the subsequently captured image becomes larger than a given detection threshold value.

In still another preferred mode of the invention, the defect detection unit is configured so that when, in the image captured of the surface of the sample, a comparison result obtained as a result of a comparison between corresponding portions that should normally be identical to each other satisfies the prescribed detection condition, the corresponding portions are detected as defect candidates.

In this case, the inspection condition determining unit is configured to determine at least one of the prescribed optical condition and the prescribed detection condition by successively changing the at least one condition while the defect detection unit repeatedly detects the standard defect, until a detection result of the standard defect matches a prescribed target condition.

For example, when the defect detection unit detects defects in each of a plurality of regions having the same area size and containing standard defects distributed at the same density, the inspection condition determining unit may determine at least one of the prescribed optical condition and the prescribed detection condition by successively changing the at least one condition until the number of standard defects detected in each region reaches a desired number.

According to a second aspect of the present invention, there is provided a surface inspection method for detecting a defect on a surface of a sample by inspecting an image captured of the surface of the sample under a prescribed optical condition, comprising: a defect detection step for detecting a defect appearing in the image by using a prescribed detection condition; and an inspection condition determining step for setting at least one of the prescribed optical condition and the prescribed detection condition to a condition under which a known standard defect formed in advance on an inspection surface of the sample to be inspected can be detected in the defect detection step.

### BRIEF DESCRIPTION OF THE DRAWINGS

The present invention will be more clearly understood from the description as set below with reference to the accompanying drawings, wherein:

FIG. 1 is a block diagram of a surface inspection apparatus according to the prior art;

FIG. 2 is a diagram showing an arrangement of dies on a semiconductor wafer;

FIG. 3 is a block diagram showing a configuration example of a detection threshold value calculation unit 23;

FIGS. 4A to 4C are diagrams for explaining how a detection threshold value is calculated by the detection threshold value calculation unit shown in FIG. 3;

FIG. 5 is a general block diagram of a surface inspection apparatus according to a first embodiment of the present invention;

FIG. 6 is a block diagram showing a configuration example of a microscope unit shown in FIG. 5;

FIG. 7 is a block diagram showing a configuration example of an image processing unit shown in FIG. 5;

FIG. 8 is a diagram showing an example of an arrangement of standard defects;

FIG. 9A is an enlarged view of the original pattern formed on the surface of a wafer 2;

FIG. 9B is a diagram showing standard defects formed on the pattern of FIG. 9A;

FIG. 10 is a block diagram showing a first configuration example of an inspection condition determining unit shown in FIG. 5;

FIG. 11 is a block diagram showing a configuration example of an inspection condition computing unit shown in FIG. 10;

FIG. 12 is a flowchart of an inspection condition determination method according to a first embodiment of the present invention;

FIGS. 13A and 13B are diagrams for explaining a method of determining a detection threshold value in FIG. 12;

FIG. 14 is a diagram for explaining one example of a method of determining a standard defect gray level difference;

FIG. 15 is a flowchart of an inspection condition determination method according to a second embodiment of the present invention;

FIG. 16 is a diagram for explaining a method of determining a detection threshold value in FIG. 15;

FIG. 17 is a block diagram showing a second configuration example of the inspection condition determining unit shown in FIG. 5;

FIG. 18 is a block diagram showing a configuration example of an inspection condition judging unit shown in FIG. 17;

FIG. 19A is a flowchart of an inspection condition determination method according to a third embodiment of the present invention;

FIG. 19B is a flowchart of a tentative detection threshold value determining routine called from the flowchart of FIG. 19A;

FIG. 20 is a general block diagram of a surface inspection apparatus according to a second embodiment of the present invention;

FIG. 21 is a block diagram showing a configuration example of a microscope unit shown in FIG. 20;

FIG. 22 is a block diagram showing a configuration example of an image processing unit shown in FIG. 20;

FIG. 23 is a block diagram showing a first configuration example of an inspection condition determining unit shown in FIG. 20;

FIG. 24 is a block diagram showing a configuration example of an inspection condition computing unit shown in FIG. 23;

FIG. 25 is a flowchart of an inspection condition determination method according to a fourth embodiment of the present invention;

FIG. 26 is a flowchart of an inspection condition determination method according to a fifth embodiment of the present invention;

FIG. 27 is a flowchart of an inspection condition determination method according to a sixth embodiment of the present invention;

FIG. 28 is a block diagram showing a second configuration example of the inspection condition determining unit shown in FIG. 20;

FIG. 29 is a block diagram showing a configuration example of an inspection condition judging unit shown in FIG. 28;

FIG. 30A is a flowchart of an inspection condition determination method according to a seventh embodiment of the present invention; and

FIG. 30B is a flowchart of a detection result acquiring routine called from the flowchart of FIG. 30A.

### DESCRIPTION OF THE PREFERRED EMBODIMENTS

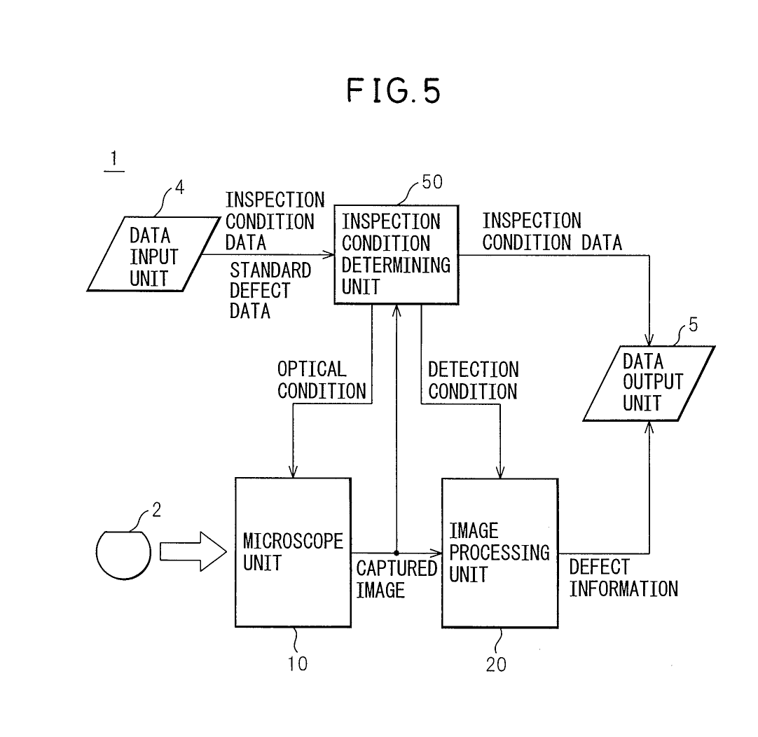

The preferred embodiments of the present invention will be described in detail below while referring to the attached figures. FIG. 5 is a general block diagram of a surface inspection apparatus according to a first embodiment of the present invention. The surface inspection apparatus 1 comprises: a microscope unit 10 as an optical system for acquiring an image by capturing an optical image of the surface of the actual wafer 2 to be inspected; an image processing unit 20 which takes as an input the image captured by the microscope unit 10 and detects a defect appearing in the captured image; and an inspection condition determining unit 50.

Here, the inspection condition determining unit 50 has the function of determining optical conditions under which the optical system, i.e., the microscope unit 10, captures the image of the surface of the wafer 2, and detection conditions to be used when detecting a defect in the defect detection process performed by the image processing unit 20. The image processing unit 20 and the inspection condition determining unit 50 may be implemented using a computer or the like that performs data processing and mathematical operations.

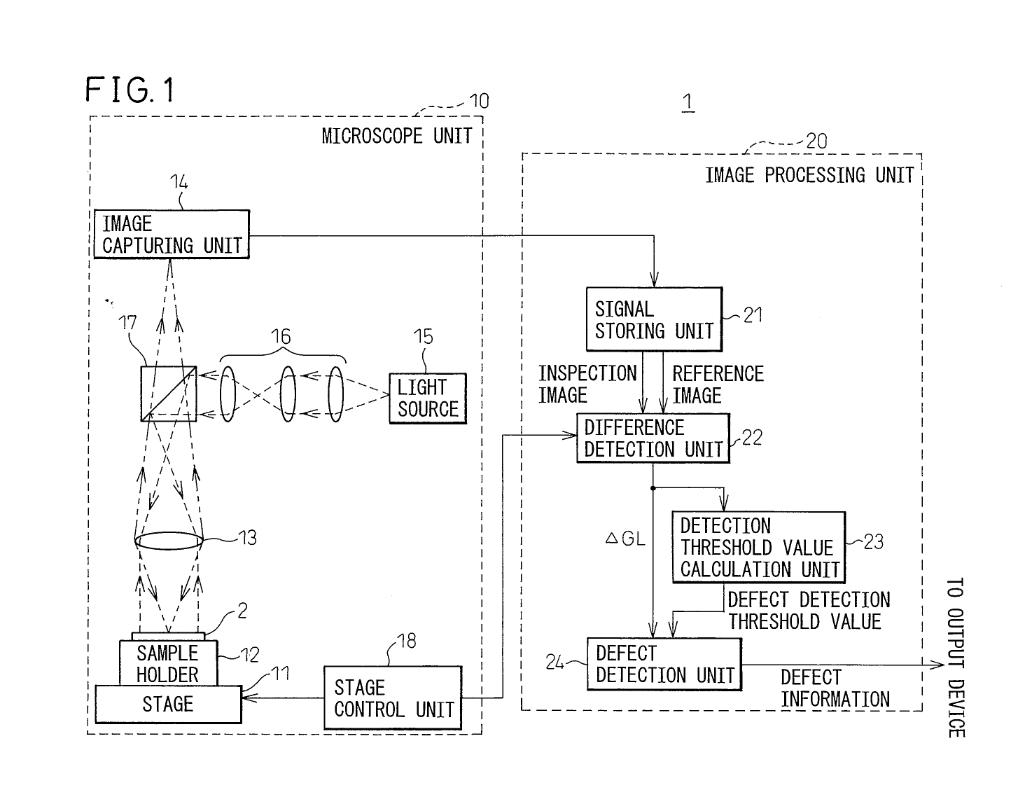

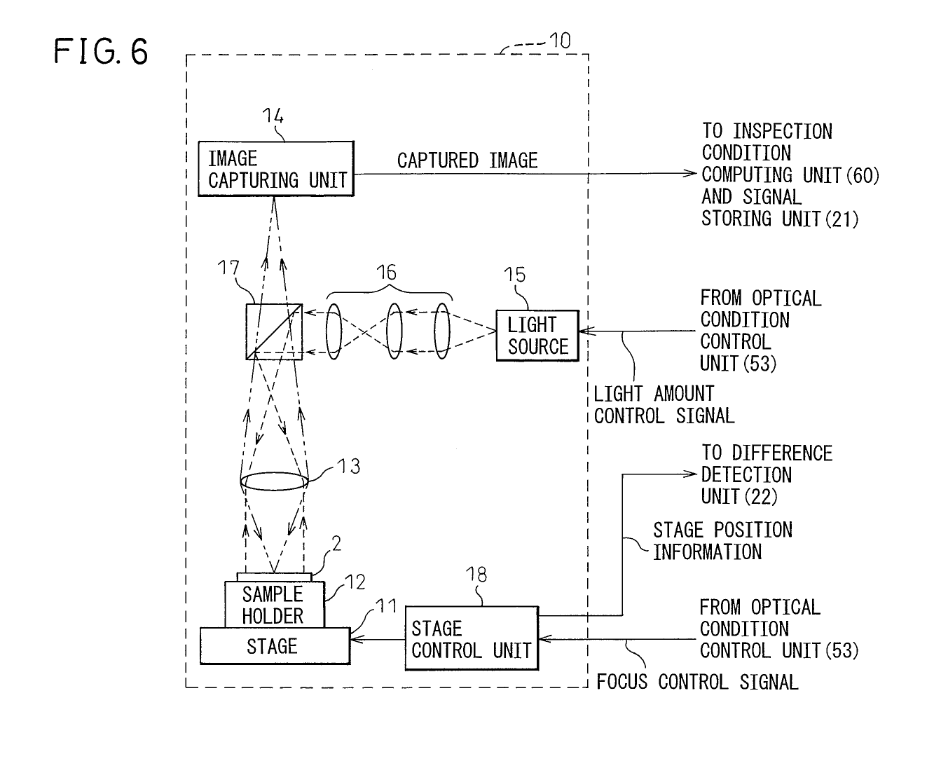

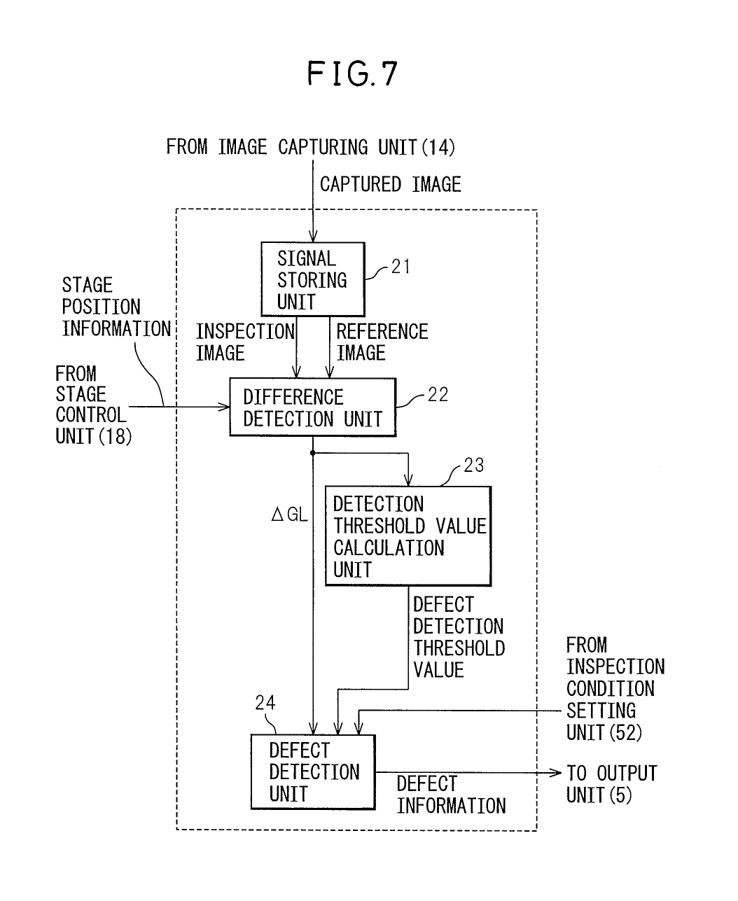

FIG. 6 is a block diagram showing a configuration example of the microscope unit 10 shown in FIG. 5, and FIG. 7 is a block diagram showing a configuration example of the image processing unit 20. The microscope unit 10 and the image processing unit 20 shown in FIGS. 6 and 7, respectively, are similar in configuration to the corresponding units in the surface inspection apparatus previously described with reference to FIG. 1; therefore, the same component elements are designated by the same reference numerals, and the description of the same functions will not be repeated here.

In the following description, as an example of the optical condition that the inspection condition determining unit 50 determines for the microscope unit 10, the amount of light to be emitted from the light source 15 shown in FIG. 6 is considered. Further, as an example of the optical condition, the focusing condition is considered that can be adjusted by moving the stage 11 and hence the sample holder 12 up and down thereby changing the relative distance between the wafer 2 and the focusing optical system including the objective lens 13.

On the other hand, as an example of the detection condition that the inspection condition determining unit 50 determines for the image processing unit 20, the detection threshold value T is considered with which the gray level difference (ΔGL) output from the difference detection unit 22 is compared when detecting a defect using the defect detection unit 24 shown in FIG. 7.

In this patent specification, the conditions, such as the optical conditions for the microscope unit 10 and the detection conditions for the image processing unit 20, that the inspection condition determining unit 50 determines may be collectively referred to as the “inspection conditions.”

When a wafer with prescribed standard defects formed on its inspection surface is loaded as a sample to be inspected into the surface inspection apparatus 1, the microscope unit 10 captures the image of the inspection surface of the sample and, based on the thus captured image, the inspection condition determining unit 50 sets the inspection conditions to be used in the surface inspection apparatus 1.

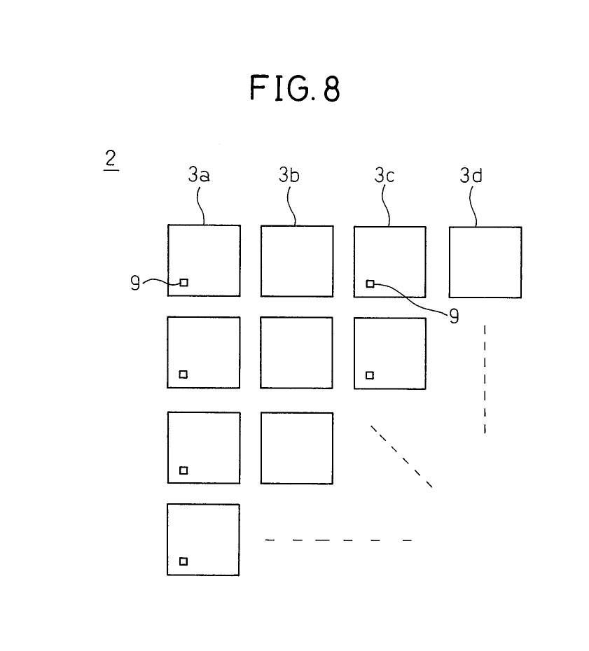

FIG. 8 shows an example of an arrangement of the standard defects. A plurality of dies 3a, 3b, 3c, 3d, . . . are formed on the surface of the wafer 2 in a matrix pattern in repeated fashion in the X and Y directions. The standard defects 9 are provided, for example, one for every two or more dies arranged in repeated fashion.

When the standard defects 9 are provided in this manner, then when a die-to-die comparison is made between adjacent dies, for example, dies 3a and 3b, the standard defect 9 formed on the die 3a can be detected in the same manner as when detecting an actual defect, because the gray level of the image captured from the portion of the standard defect 9 on the die 3a substantially differs from that of the image captured from the corresponding portion on the other die 3b (i.e., the position on the die 3b that corresponds to the position on the die 3a at which the standard defect 9 is formed).

In a like manner, when determining the inspection conditions to be used in cell-to-cell comparison inspection, the standard defects 9 may be provided one for every two or more cells arranged in repeated fashion.

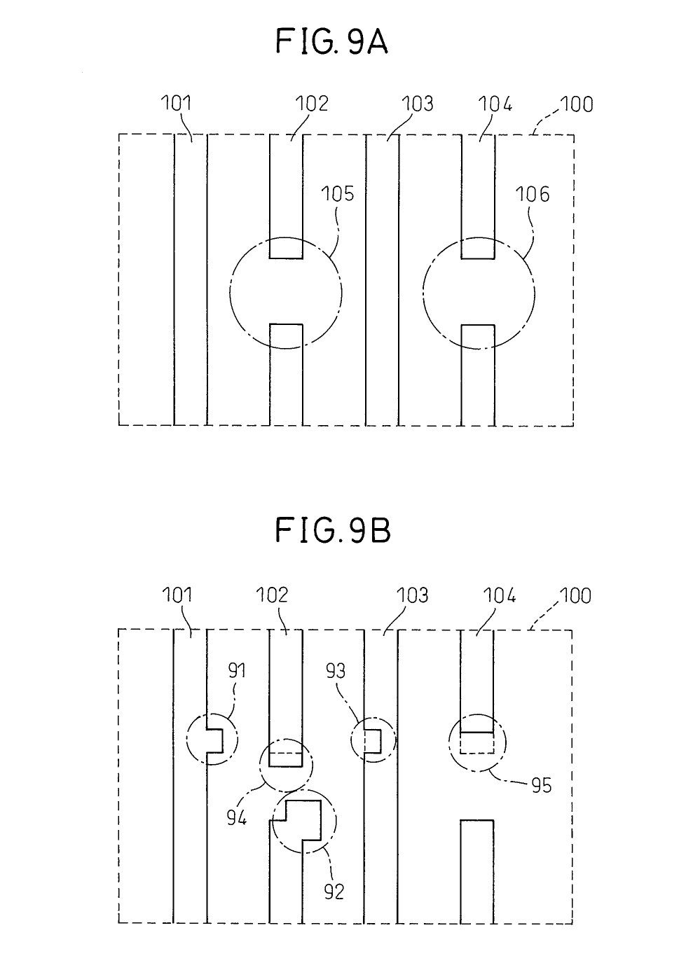

FIG. 9A is an enlarged view of a pattern formed on the surface of the wafer 2, i.e., the original pattern that does not contain any standard defects, and FIG. 9B is a diagram showing standard defects formed on the pattern of FIG. 9A.

As shown in FIG. 9A, the pattern formed in a given region 100 on the surface of the wafer 2 comprises a plurality of conductive circuit lines 101 to 104, of which the line 102 has a cut portion at the position indicated by reference numeral 105 while the line 104 has a cut portion at the position indicated by 106.

The standard defects here may be formed as microscopic defects with conductive portions overflowing from the original regions of the conductive lines 101 and 102, as shown, for example, at positions 91 and 92 in FIG. 9B. Further, the standard defects may be formed as microscopic defects with conductive portions partially eroded, such as a portion 93 where a portion of the conductive line 103 is eroded.

Alternatively, the standard defects may be formed by extending or shortening the line length as shown in portions 94 and 95.

It is desirable that the standard defects 91 to 95 be formed so as to have minimum dimensions, i.e., minimum width, minimum length, etc., that the surface inspection apparatus 1 can detect. Further, the standard defects 91 to 95 may be formed in the same manufacturing process in which the patterns to be inspected are formed on the surface of the wafer 2. Alternatively, the standard defects may be formed on the surface of the wafer 2 before or after forming the patterns to be inspected.

Turning back to FIG. 5, the surface inspection apparatus 1 further comprises a data input unit 4 for entering inspection condition data that specifies the inspection conditions to be used for the inspection of the wafer 2 and various other data that is necessary for the operation of the inspection apparatus 1.

The inspection condition data entered via the data input unit 4 is input to the inspection condition determining unit 50 and stored therein. Then, the inspection condition determining unit 50 sets the optical conditions specified in the data for the microscope unit 10 and the defect detection conditions for the image processing unit 20.

The data input unit 4 may include any one of input devices selected from the group consisting, for example, of a user interface such as a keyboard, mouse, touch panel, etc. that an operator uses to input data, a removable media reading device, such as a flexible disk drive, a CD-ROM drive, or a memory reading device, for reading data provided in the form of a removable medium such as a flexible disk, a CD-ROM, or a memory card, and an interface device for inputting the data on-line.

All or part of the standard defect data concerning the standard defect 9 formed on the wafer 2 is input via the data input unit 4 to the inspection condition determining unit 50. The standard defect data includes at least die designation information designating the die in which the standard defect 9 is provided and standard defect position information indicating the position on the die at which the standard defect 9 is formed. If the standard defect data includes data concerning more than one standard defect 9, identifier information for identifying each individual standard defect 9 may be included.

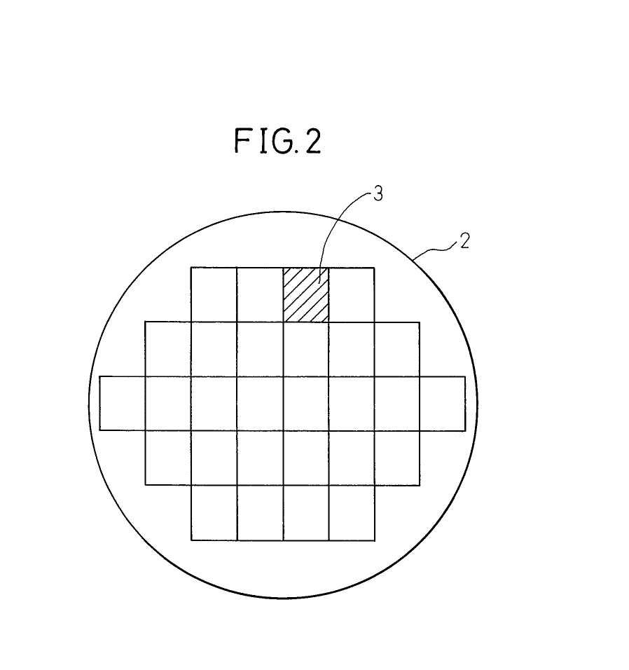

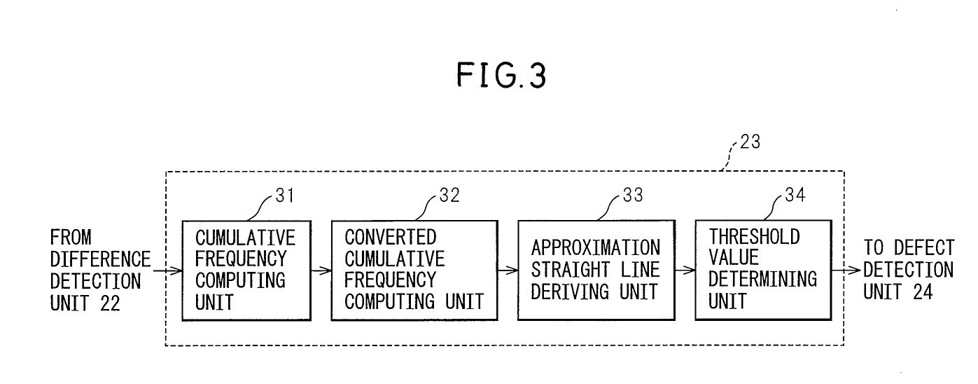

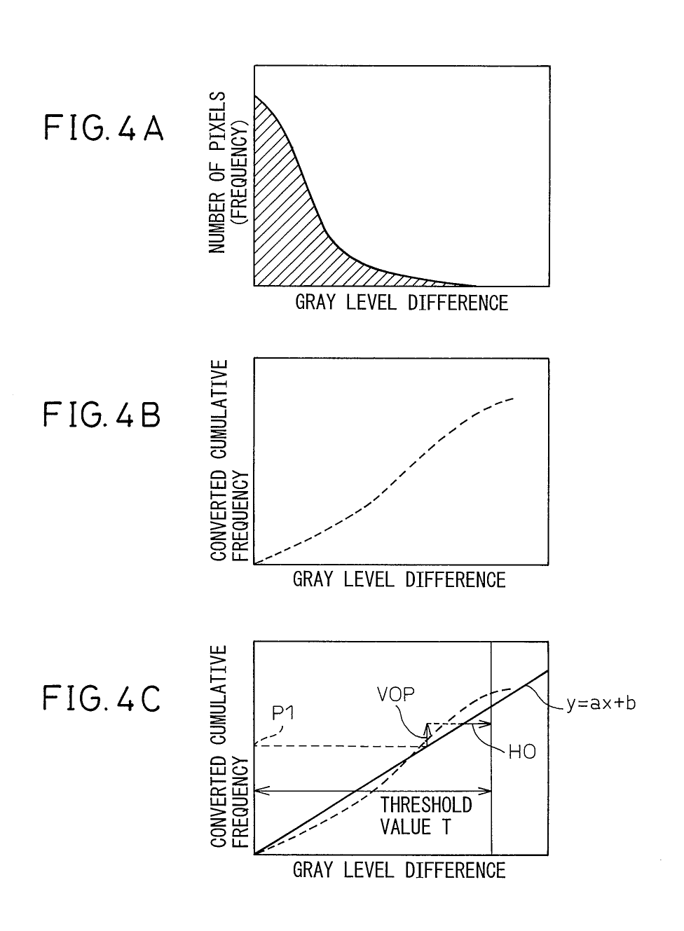

Turning back to FIG. 5, when the image of the surface of the wafer 2 with the standard defect 9 formed thereon is captured by the microscope unit 10, and the captured image is input to the signal processing unit 20, the image processing unit 20 shown in FIG. 7 detects defects on the surface of the wafer 2 by using the signal storing unit 21, difference detection unit 22, detection threshold value calculation unit 23, and defect detection unit 24, as in the surface inspection method previously described with reference to FIGS. 1 to 3 and 4A to 4C, and creates defect information for each detected defect; the thus created defect information is output from the image processing unit 20. The defect information to be output here includes defect information created by detecting the standard defect 9.

The defect information output from the image processing unit 20 is output outside the surface inspection apparatus 1 via a data output unit 5.

The data output unit 5 may include any one of output devices selected from the group consisting, for example, of a display device such as a CRT or a liquid crystal display panel on which the data to be output is displayed for viewing by the operator, a printer for printing the data on a paper medium, a removable media writing device, such as a flexible disk drive, a CD-ROM drive, or a memory writing device, for storing the data to be output and writing the data to a removable medium such as a flexible disk, a CD-ROM, or a memory card, and an interface device for outputting the data on-line.

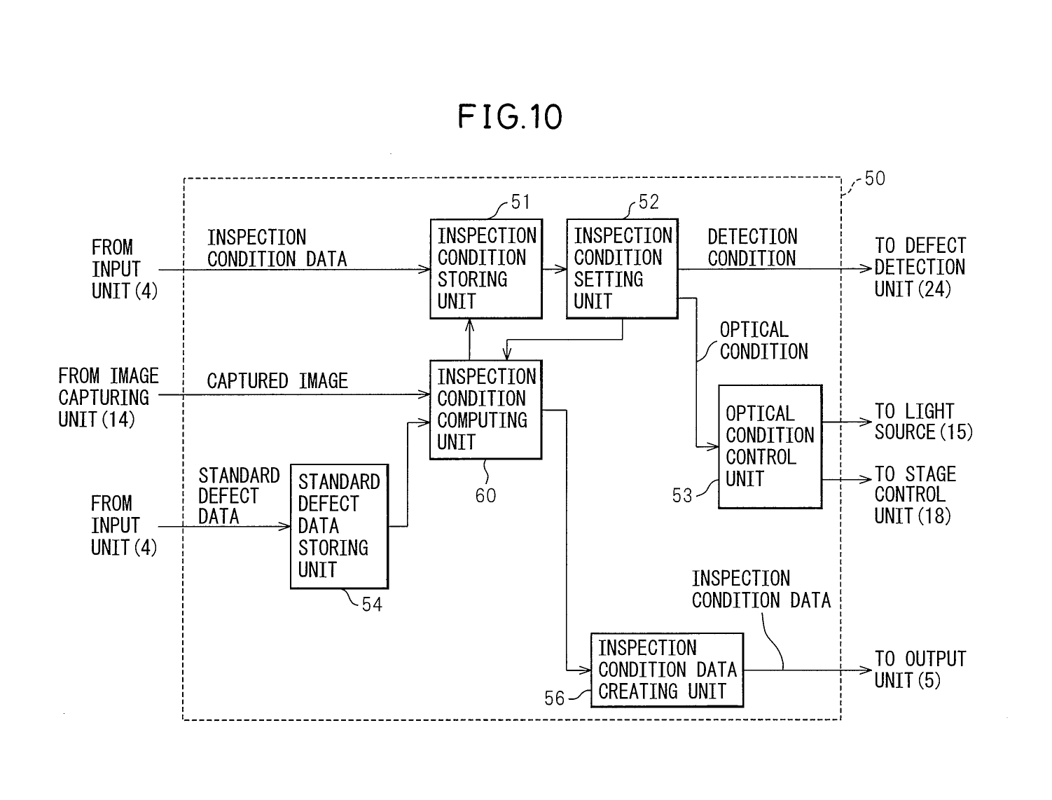

FIG. 10 is a block diagram showing a first configuration example of the inspection condition determining unit 50 shown in FIG. 5.

As shown, the inspection condition determining unit 50 comprises an inspection condition storing unit 51, an inspection condition setting unit 52, and an optical condition control unit 53.

When the inspection condition data indicating the inspection conditions to be used for the inspection of the wafer 2 is input via the data input unit 4 to the inspection condition determining unit 50, the inspection condition data is stored in the inspection condition storing unit 51.

Prior to the initiation of the inspection, the inspection condition setting unit 52 retrieves the inspection condition data from the inspection condition storing unit 51, and specifies to the image processing unit 20 the detection conditions to be used by the image processing unit 20 for the detection of defects, for example, the detection threshold value T to be used in the defect detection unit 24 in the image processing unit. Further, the inspection condition setting unit 52 specifies the optical conditions contained in the inspection condition data and to be used by the optical condition control unit 53 hereinafter described.

The optical condition control unit 53 generates a light amount control signal for increasing or decreasing the amount of light to be emitted from the light source 15 of the microscope unit 10 shown in FIG. 6, and a focus control signal for controlling the focusing condition by driving the stage 11 via the stage control unit 18 to move the sample holder 12 up and down thereby changing the relative distance between the wafer 2 and the focusing optical system. When the optical conditions are specified by the inspection condition setting unit 52, the optical condition control unit 53 generates the corresponding light amount control signal and focus control signal and supplies them to the light source 15 and the stage control unit 18, respectively.

As shown in FIG. 10, the inspection condition determining unit 50 further includes a standard defect data storing unit 54.

The standard defect data storing unit 54 stores the standard defect data input via the input unit 4. The standard defect data stored in the standard defect data storing unit 54 includes at least the position information indicating the position at which the standard defect is provided.

The inspection condition determining unit 50 further includes an inspection condition computing unit 60. The inspection condition computing unit 60 receives from the image capturing unit 14 the image captured of the surface of the wafer 2 with the standard defect formed thereon. Then, based on the captured image, the amount of light of the microscope unit 10 and the detection threshold value T for the image processing unit 20 are computed in accordance with the following method.

The amount of light and the detection threshold value T computed by the inspection condition computing unit 60 are stored in the inspection condition storing unit 51, and the thus stored inspection conditions are read out by the inspection condition setting unit 52 and used when performing the surface inspection.

The amount of light and the detection threshold value T thus computed are also input to an inspection condition data creating unit 56 where the inspection condition data is converted into a form understandable to the operator or other system, and the converted data is output via the data output unit 5.

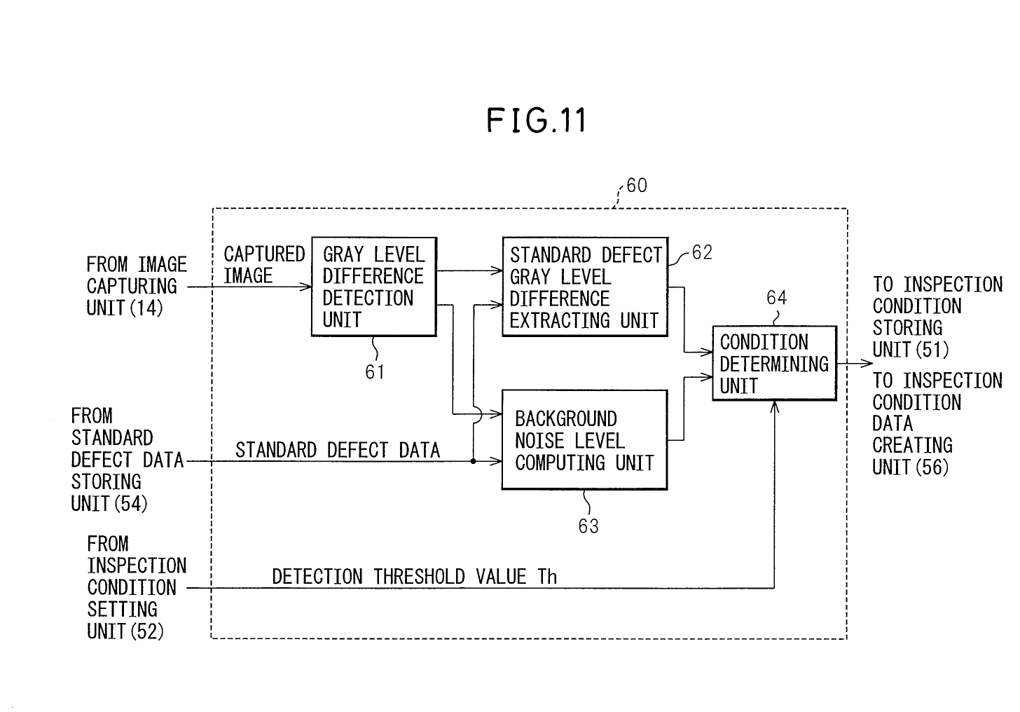

Next, referring to FIGS. 11 to 14, a description will be given of the operation of the inspection condition computing unit 60 when computing the detection threshold value T. FIG. 11 is a block diagram showing a configuration example of the inspection condition computing unit 60 shown in FIG. 10.

As shown, the inspection condition computing unit 60 comprises a gray level difference detection unit 61, a standard defect gray level difference extracting unit 62, a background noise level computing unit 63, and a condition determining unit 64.

The gray level difference detection unit 61 receives from the image capturing unit 14 the image captured of the surface of the wafer 2 with the standard defect formed thereon, and detects the gray level difference between corresponding portions in the captured image that should normally be identical to each other.

The standard defect gray level difference extracting unit 62 extracts, from among the gray level differences detected by the gray level difference detection unit 61, the gray level difference detected for the portion of the standard defect, that is, the standard gray level difference ΔGLs.

The background noise level computing unit 63 extracts, from among the gray level differences detected by the gray level difference detection unit 61, the gray level differences detected for other portions than the standard defect, that is, the gray level differences for the background, and computes the noise level N of the background of the captured image input to the inspection condition computing unit 60.

The condition determining unit 64 computes the detection threshold value T based on the standard gray level difference ΔGLs extracted by the standard defect gray level difference extracting unit 62 and on the noise level N computed by the background noise level computing unit 63.

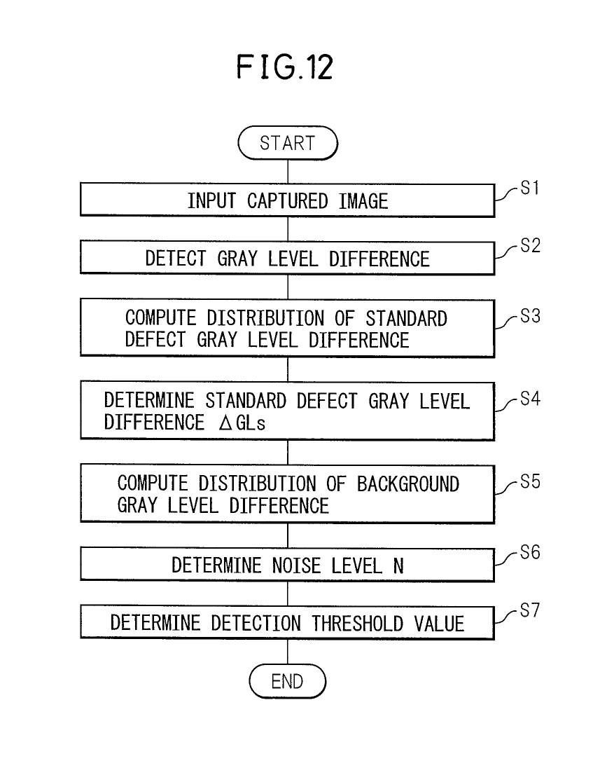

FIG. 12 is a flowchart of an inspection condition determination method according to a first embodiment of the present invention, showing how the inspection condition computing unit 60 shown in FIG. 11 determines the detection threshold value T.

In step S1, the image captured of the surface of the wafer 2 with the standard defect formed thereon is input from the image capturing unit 14 into the gray level difference detection unit 61. Then, in step S2, the gray level difference detection unit 61 detects the gray level difference between corresponding portions in the captured image that should normally be identical to each other. Here, the gray level difference detection unit 61 may detect the gray level difference between the inspection image and its corresponding reference image that the difference detection unit 22 in FIG. 7 uses when comparing patterns, for example, in the earlier described die-to-die comparison or cell-to-cell comparison.

In step S3, the standard defect gray level difference extracting unit 62 extracts, from among the gray level differences detected by the gray level difference detection unit 61, the gray level difference detected for the portion of the standard defect, that is, the standard gray level difference ΔGLs.

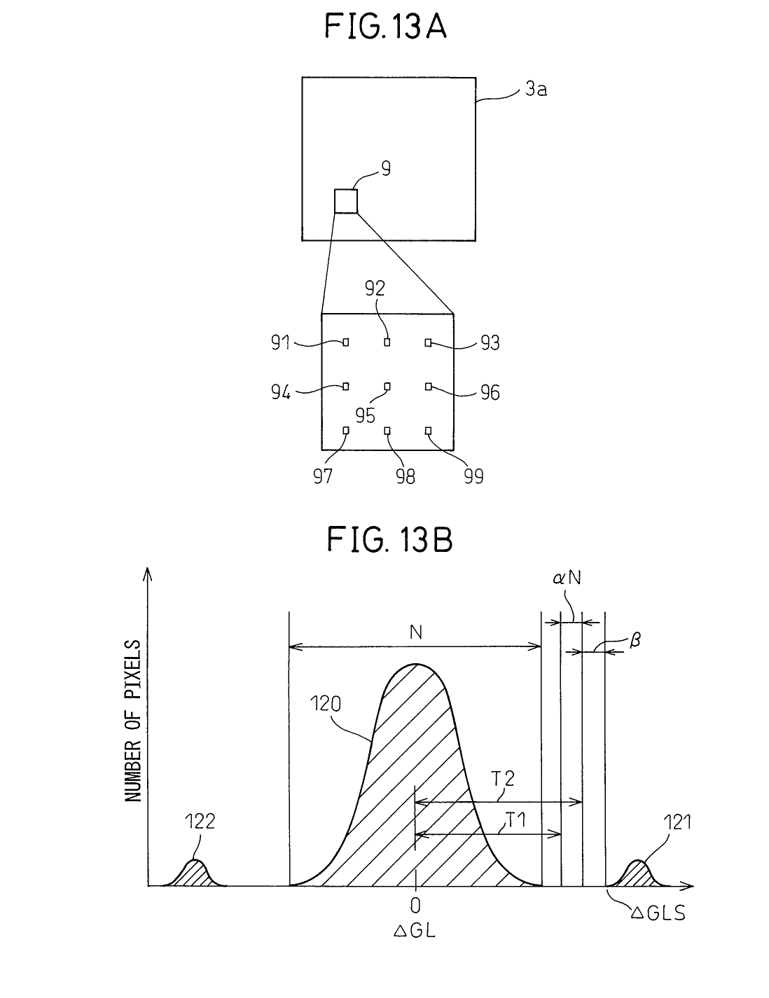

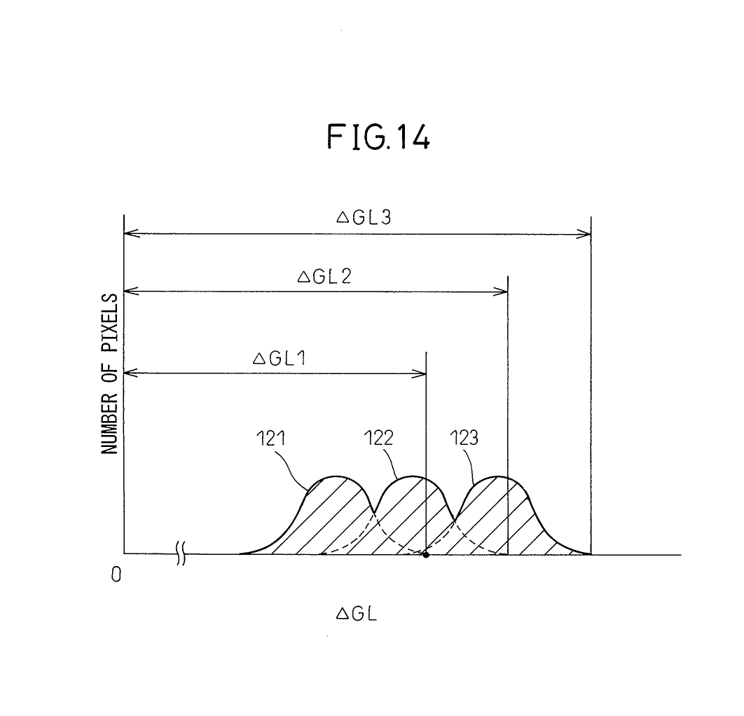

Here, the standard defect gray level difference extracting unit 62 reads out the standard defect position information stored in the standard defect data storing unit 54, and extracts only the gray level difference detected for the pixel containing the standard defect from among the gray level differences detected between corresponding pixels by the gray level difference detection unit 61. This will be explained with reference to FIGS. 13A and 13B.

FIG. 13A is a diagram showing a die 3a with standard defects 91 to 99 formed in a region 9 thereof. When gray level differences are detected between the die 3a and its adjacent die with no standard defects formed thereon, the distribution of the detected gray level differences ΔGL in the region 9 containing the standard defects 91 to 99 can be obtained as shown in FIG. 13B.

In the gray level difference distribution, the portion 120 shown in the range containing the gray level difference ΔGL=0 represents the distribution of the background gray level differences detected for the pixels located within the region 9, except those pixels containing the standard defects 91 to 99, while the portions 121 and 122 where the absolute gray level differences are larger than the gray level differences detected in the portion 120 represent the distributions of the gray level differences detected for the standard defects 91 to 99.

The standard defect gray level difference extracting unit 62 extracts only the gray level differences detected for the pixels containing the standard defects, thereby obtaining the gray level difference distributions as shown in the portions 121 and 122.

In step S4, the standard defect gray level difference extracting unit 62 determines a representative value representing the gray level differences having the distributions shown in the portions 121 and 122, and takes it as the standard defect gray level difference ΔGLs.

The standard defect gray level difference ΔGLs is used in a subsequent step as a value based on which to determine the detection threshold value T. The detection threshold value T must be set so that all the standard defects 91 to 99 can be detected. Accordingly, the standard defect gray level difference extracting unit 62 selects the gray level difference whose absolute value is the smallest in the distributions shown in the portions 121 and 122, and takes it as the standard defect gray level difference ΔGLs.

Since each pixel value in the captured image varies according to the noise level of the image, it is preferable to provide a margin for the detection threshold value T in accordance with the noise level. Here, the noise level can be assumed to be a quantity proportional to the variance of the background.

Accordingly, in step 5, the background noise level computing unit 63 extracts, from among the gray level differences detected by the gray level difference detection unit 61, the gray level differences detected for other portions than the standard defects, that is, the gray level differences for the background. The distribution of the thus extracted gray level differences is as shown in the portion 120 in FIG. 13B.

In step S6, the noise level N of the background of the captured image input to the inspection condition computing unit 60 is computed. The noise level here may be determined, for example, as the variance of the background gray level differences extracted in step S5, or simply as the width of the distribution of the gray level differences detected for other portions than the standard defects.

In step S7, the condition determining unit 64 calculates a detection threshold value T1 by adding a margin (α×N)+β appropriate to the noise level N computed by the background noise level computing unit 63 to the standard defect gray level difference ΔGLs extracted by the standard defect gray level difference extracting unit 62, that is,

T1=ΔGLs−(α×N)−β (1)

and determines this value as the detection threshold value T. Here, α and β are predetermined constants. Or more simply, the condition determining unit 64 calculates a detection threshold value T2 by simply adding a prescribed margin β, that is

T2=ΔGLs−β (2)

and determines this value as the detection threshold value T.

FIG. 14 is a diagram for explaining one example of a method of determining the standard defect gray level difference ΔGLs. When determining the standard defect gray level difference ΔGLs in step S4, the standard defect gray level difference extracting unit 62 may obtain representative values representing the respective gray level differences detected for the respective standard defects 91 to 99 to be used for determining the standard defect gray level difference ΔGLs, and may take the smallest of these representative values as the standard defect gray level difference ΔGLs.

In the example of FIG. 14, the maximum values of the gray level difference distributions 121 to 123 respectively detected for three standard defects are taken as the representative values ΔGL1, ΔGL2, and ΔGL2, respectively, of which the smallest value ΔGL1 is determined as the standard defect gray level difference ΔGLs.

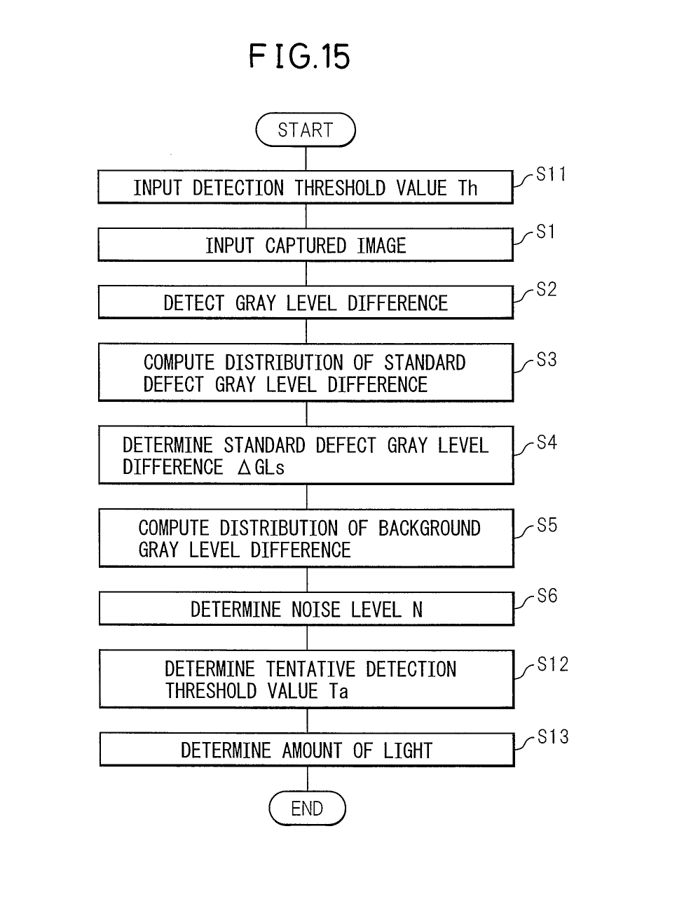

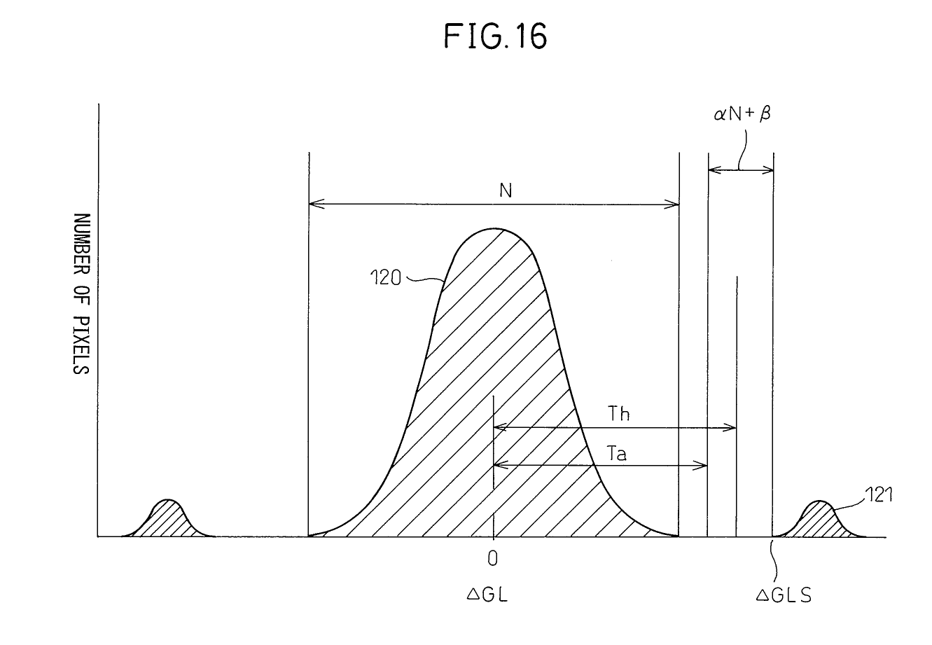

Next, referring to FIGS. 15 and 16, a description will be given of the operation of the inspection condition computing unit 60 in FIG. 11 when computing the amount of light of the light source 15 of the microscope unit 10. FIG. 15 is a flowchart of an inspection condition determination method according to a second embodiment of the present invention, showing how the inspection condition computing unit 60 shown in FIG. 11 determines the amount of light of the light source 15.

To determine the amount of light of the light source 15, the inspection condition computing unit 60 assumes in advance the detection threshold value Th to be used, and determines the amount of light of the light source 15 that would be suitable for detecting defects with the thus assumed detection threshold value Th. For example, the inspection condition computing unit 60 determines the amount of light of the light source 15 so that when the wafer 2 is illuminated with the amount of light determined by the inspection condition computing unit 60, the detection threshold value computed for the captured image at this time in the same manner as the threshold value T1 or T2 earlier described with reference to FIGS. 13A and 13B will become equal to the detection threshold value Th assumed in advance.

The method of setting the amount of light of the light source 15 will be described below with reference to FIG. 15. First, in step S11, to determine the detection threshold value Th in advance, the inspection condition computing unit 60 receives the currently used detection threshold value Th from the inspection condition setting unit 52 as shown, for example, in FIG. 11. The detection threshold value Th thus received is input to the condition determining unit 64.

In the subsequent steps S1 to S6, the standard defect gray level difference ΔGLs and the noise level N are determined in the same manner as in S1 to S6 of the flowchart shown in FIG. 12.

In step S12, the condition determining unit 64 calculates a tentative detection threshold value Ta in accordance with the same calculation method as that used for the calculation of the threshold value T1 or T2 in S7 of the flowchart shown in FIG. 12, that is,

Ta=ΔGLs−(α×N)−β (3)

or

Ta=ΔGLs−β (4)

where α and β are predetermined constants.

The tentative detection threshold value Ta indicates the detection threshold value suitable for use when detecting defects with the current amount of light of the light source 15. Accordingly, as shown in FIG. 16, the tentative detection threshold value Ta may differ from the detection threshold value Th determined irrespectively of the current amount of light of the light source 15.

Then, in step S13, the condition determining unit 64 determines the amount of light of the light source 15 so that the tentative detection threshold value Ta becomes equal to the given detection threshold value Th.

Here, the gray level difference that the gray level difference detection unit 61 detects is proportional to the amount of light of the light source 15. Accordingly, denoting the current amount of light of the light source 15 as L1, and the target amount of light as L2, if the tentative detection threshold value Ta determined in the same manner as described above for the image captured of the sample illuminated with the amount of light L2 is to become equal to the detection threshold value Th, then the following relation holds between the current tentative detection threshold value Ta and the given detection threshold value Th.

L1/L2=Ta/Th (5)

### Accordingly, the condition determining unit 64 calculates the target amount of light, L2, of the light source 15 from the following equation.

L2=L1×Th/Ta (6)

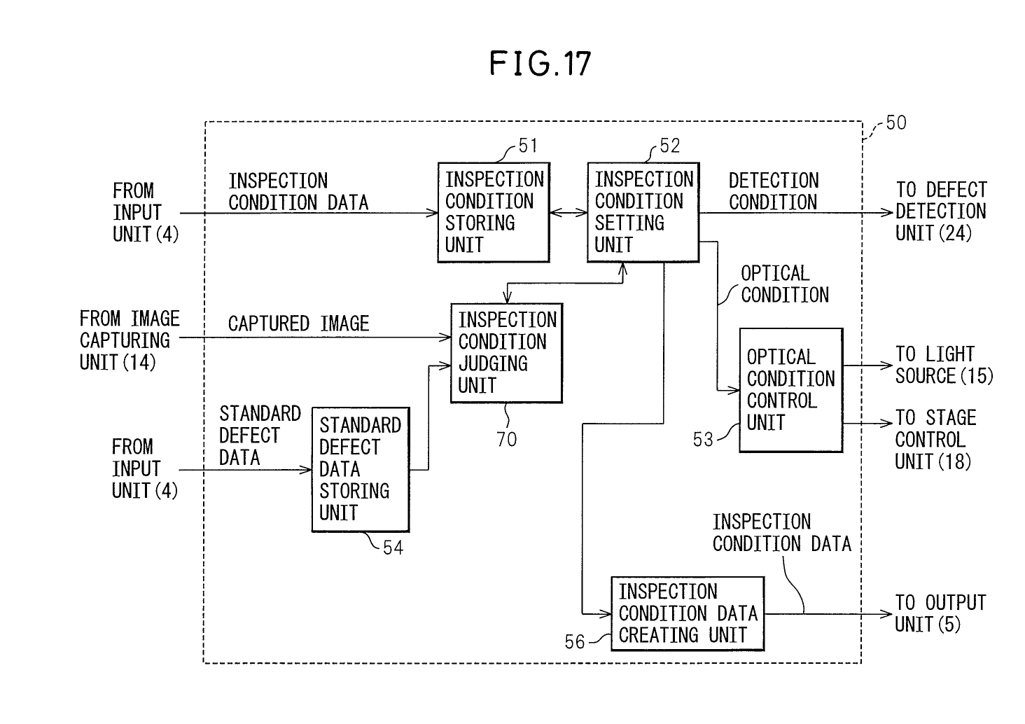

FIG. 17 is a block diagram showing a second configuration example of the inspection condition determining unit 50 shown in FIG. 5. Since the inspection condition determining unit 50 shown in FIG. 17 is similar in configuration to the inspection condition determining unit 50 shown in FIG. 10, similar component elements are designated by like reference numerals, and the description of the same functions that the similar component elements are supposed to have will not be repeated here.

In this embodiment, the inspection condition determining unit 50 includes an inspection condition judging unit 70. The inspection condition judging unit 70 judges whether, in the image captured under given optical conditions defining the amount of light of the light source 15 of the microscope unit 10, the focusing condition of the microscope unit 10, etc., the standard defect gray level difference ΔGLs obtained in the same manner as in S1 to S4 of the flowchart shown in FIG. 12 satisfies a given detection condition, for example, whether or not it exceeds the detection threshold value Th given from the inspection condition setting unit 52.

While the image capturing unit 14 is repeatedly capturing images of the surface of the wafer 2, the inspection condition setting unit 52 changes at least one of the inspection conditions. Here, the action of the image capturing unit 14 meant by the phrase “repeatedly capturing images” not only includes, for example, capturing an image of the same wafer 2 a plurality of times, but also includes capturing respective images of different wafers 2 on which similar standard defects are formed. In particular, when performing surface inspection by sequentially changing wafers, “repeatedly capturing images” also includes the action of capturing an image of each wafer 2 at least once while the different wafers 2 are loaded into the surface inspection apparatus 1 one after another.

Further, “repeatedly capturing images” also includes the action of capturing images of different regions of the same wafer 2 at different times in a single sequence of image capturing operations, such as when the image capturing unit 14 captures images by scanning across the wafer 2.

When the inspection condition setting unit 52 changes the optical condition while the image capturing unit 14 is repeatedly capturing images of the surface of the wafer 2, the inspection condition judging unit 70 takes as an input each image captured under the optical condition changed by the inspection condition setting unit 52, and judges whether the standard defect gray level difference ΔGLs obtained for the thus captured image satisfies the given detection condition.

On the other hand, when the inspection condition setting unit 52 changes the detection condition while the image capturing unit 14 is repeatedly capturing images of the surface of the wafer 2, the inspection condition judging unit 70 judges whether the standard defect gray level difference ΔGLs obtained for each captured image input from the image capturing unit 14 satisfies the detection condition changed by the inspection condition setting unit 52.

When the standard defect gray level difference ΔGLs is judged to satisfy the detection condition, the inspection condition judging unit 70 outputs an inspection condition change stopping signal instructing the inspection condition setting unit 52 to stop changing the inspection condition. As a result, the inspection condition is set to a condition under which the standard defect formed on the wafer 2 can be detected.

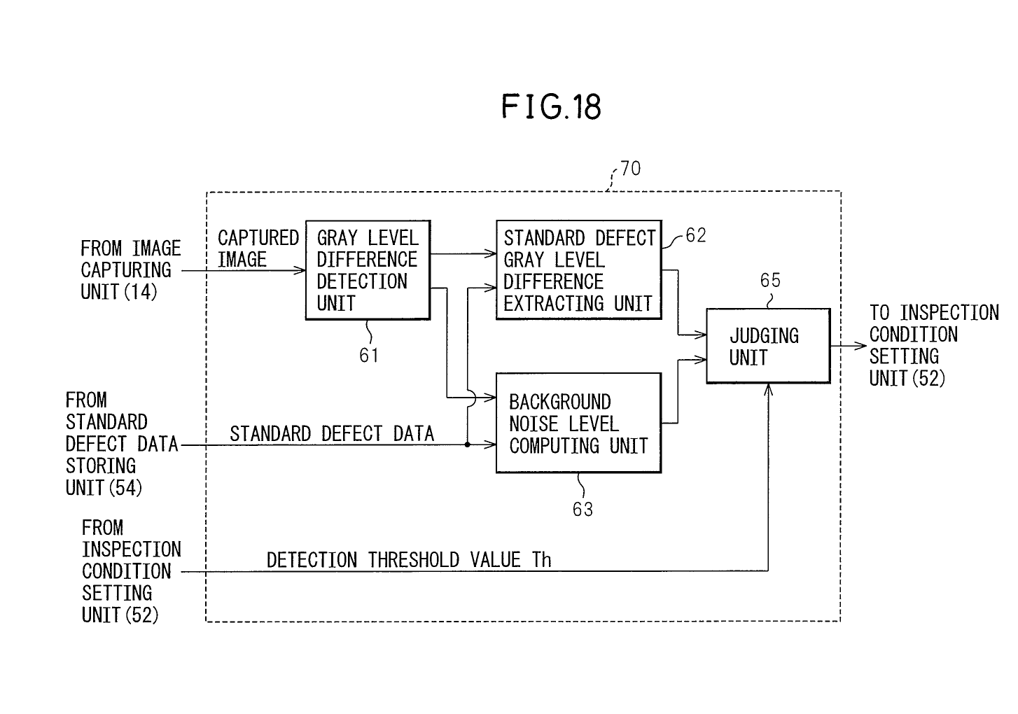

FIG. 18 is a block diagram showing a configuration example of the inspection condition judging unit 70 shown in FIG. 17. Since the inspection condition judging unit 70 is similar in configuration than the inspection condition computing unit 60 shown in FIG. 11, the same component elements are designated by the same reference numerals, and the description of the same functions will not be repeated here.

The inspection condition judging unit 70 includes a judging unit 65. The judging unit 65 judges whether the standard defect gray level difference ΔGLs obtained by the standard defect gray level difference extracting unit 62 in the same manner as in S1 to S4 of the flowchart shown in FIG. 12 exceeds the detection threshold value Th given from the inspection condition setting unit 52, and outputs the inspection condition change stopping signal to the inspection condition setting unit 52 if the standard defect gray level difference ΔGLs exceeds the detection threshold value Th.

More specifically, the inspection condition judging unit 70 determines the tentative detection threshold value Ta in the same manner as in S1 to S6 and S12 of the flowchart shown in FIG. 15, and when the difference between the tentative detection threshold value Ta and the detection threshold value Th given from the inspection condition setting unit 52 becomes smaller than a predetermined value Δ, the inspection condition judging unit 70 outputs the inspection condition change stopping signal to the inspection condition setting unit 52 to stop changing the inspection condition.

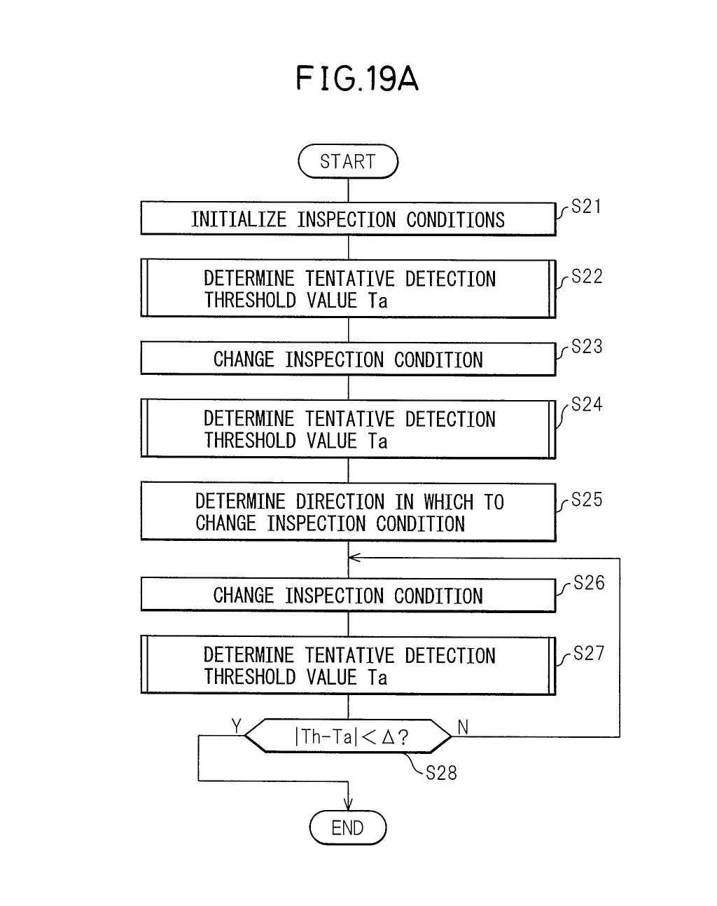

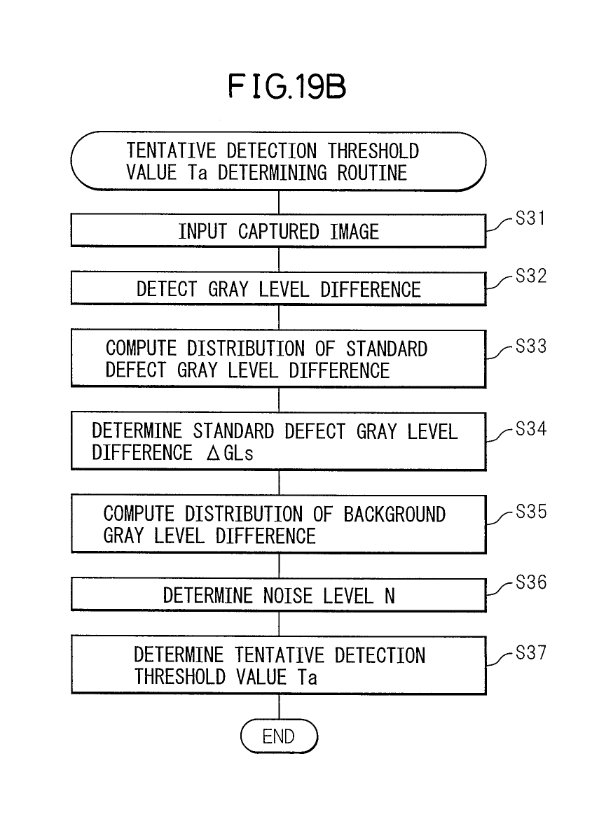

FIG. 19A is a flowchart of an inspection condition determination method according to a third embodiment of the present invention, which is implemented by the inspection condition determining unit 50 shown in FIG. 5.

In step S21, the inspection condition setting unit 52 initializes the inspection conditions, i.e., the optical conditions for the microscope unit 10 and the detection threshold value Th for the image processing unit, to predetermined states. Here, the initialization of the inspection conditions in step S21 is not mandatory, and the process may proceed directly to step S22 while using the current inspection conditions.

In step S22, the inspection condition judging unit 70 determines the tentative detection threshold value Ta. FIG. 19B is a flowchart of a tentative detection threshold value determining routine called from the flowchart of FIG. 19A.

In steps S31 and S32, the gray level difference detection unit 61 detects the gray level difference in the same manner as in the steps S1 and S2 of the flowchart shown in FIG. 15.

In steps S33 and S34, the standard defect gray level difference extracting unit 62 determines the standard defect gray level difference ΔGLs in the same manner as in the steps S3 and S4 of the flowchart shown in FIG. 15.

In steps S35 and S36, the background noise level computing unit 63 determines the noise level N in the same manner as in the steps S5 and S6 of the flowchart shown in FIG. 15.

In step S37, the judging unit 65 determines the tentative detection threshold value Ta in the same manner as in step S12 shown in FIG. 15. The judging unit 65 supplies the thus determined tentative detection threshold value Ta to the inspection condition setting unit 52 which temporarily stores it in a storage means not shown.

Turning back to FIG. 19A, in step S23 the inspection condition setting unit 52 changes at least one of the inspection conditions. In step S24 after changing the inspection condition, the inspection condition judging unit 70 determines the tentative detection threshold value Ta and supplies it to the inspection condition setting unit 52.

In step S25, the inspection condition setting unit 52 determines the direction in which the inspection condition is to be changed, by checking which of the two tentative detection threshold values Ta, one determined in step S22 and the other determined in step S24, is closer to the current detection threshold value Th.

For example, if the tentative detection threshold value Ta determined in step S24 is closer to the current detection threshold value Th than the tentative detection threshold value Ta determined in step S22 is, the inspection condition setting unit 52 determines that the detection threshold value should be changed in the subsequent step (S26) in the same direction in which it was changed in step S23.

Conversely, if the tentative detection threshold value Ta determined in step S22 is closer to the current detection threshold value Th than the tentative detection threshold value Ta determined in step S24 is, the inspection condition setting unit 52 determines that the detection threshold value should be changed in the subsequent step in the direction opposite to the direction in which it was changed in step S23.

Then, in step S26, the inspection condition setting unit 52 changes the inspection condition in the direction determined in step S25. In step S27, the inspection condition judging unit 70 determines the tentative detection threshold value Ta.

In step S28, the inspection condition judging unit 70 judges whether the difference between the tentative detection threshold value Ta and the current detection threshold value Th is smaller than the predetermined value Δ and, if the difference between Ta and Th (|Th−Ta|) is smaller than the predetermined value Δ, the inspection condition judging unit 70 outputs the inspection condition change stopping signal to the inspection condition setting unit 52 to stop changing the inspection condition, otherwise the process returns to step S26 to repeat the steps S26 to S28.

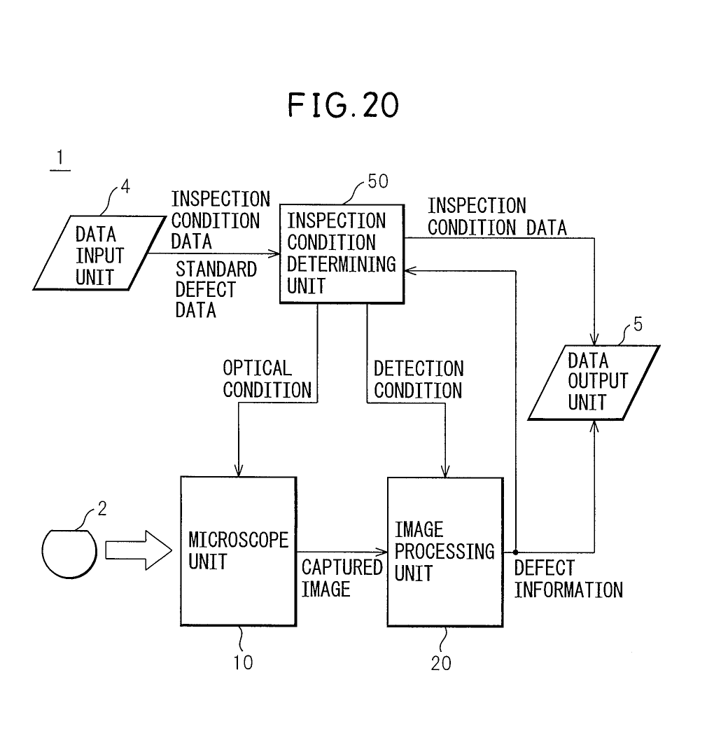

FIG. 20 is a general block diagram of a surface inspection apparatus according to a second embodiment of the present invention. The surface inspection apparatus 1 shown in FIG. 20 is similar in configuration to the surface inspection apparatus 1 shown in FIG. 5. Therefore, the same component elements are designated by the same reference numerals, and the description of the same functions will not be repeated here.

In this embodiment, the image processing unit 20 detects the standard defect formed on the wafer 2 and, based on the defect information created by the image processing unit 20, the inspection condition determining unit 50 determines the optical conditions for the microscope unit 10 and the detection conditions for the image processing unit 20.

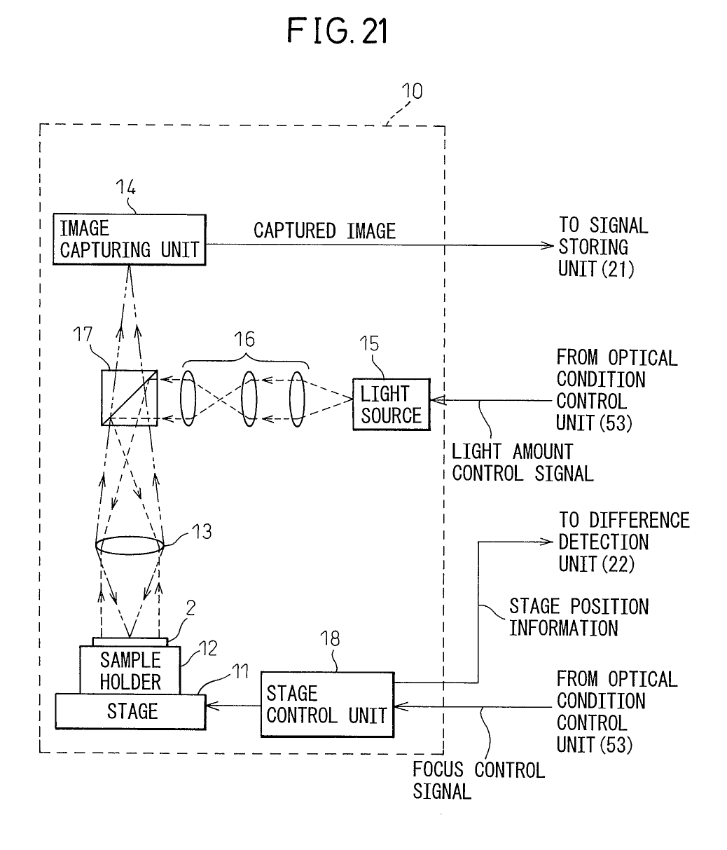

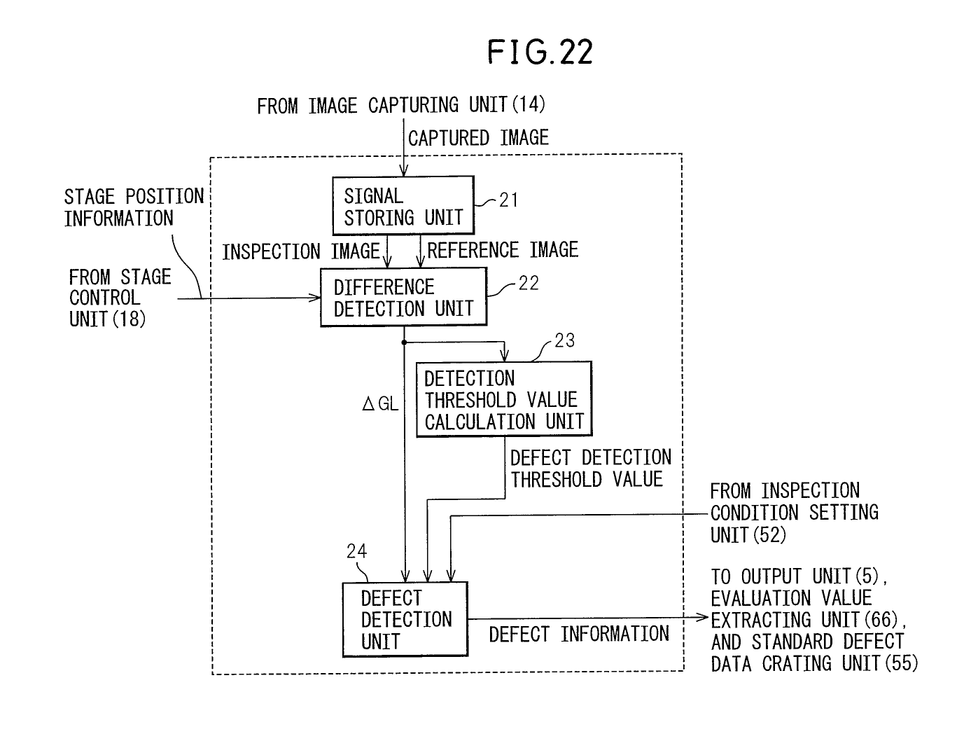

FIGS. 21 and 22 are block diagrams respectively showing configuration examples of the microscope unit 10 and the image processing unit 20 shown in FIG. 20. Since the microscope unit 10 and the image processing unit 20 are similar in configuration to the microscope unit 10 and the image processing unit 20 previously shown in FIGS. 6 and 7, respectively, the same component elements are designated by the same reference numerals, and the description of the same functions will not be repeated here.

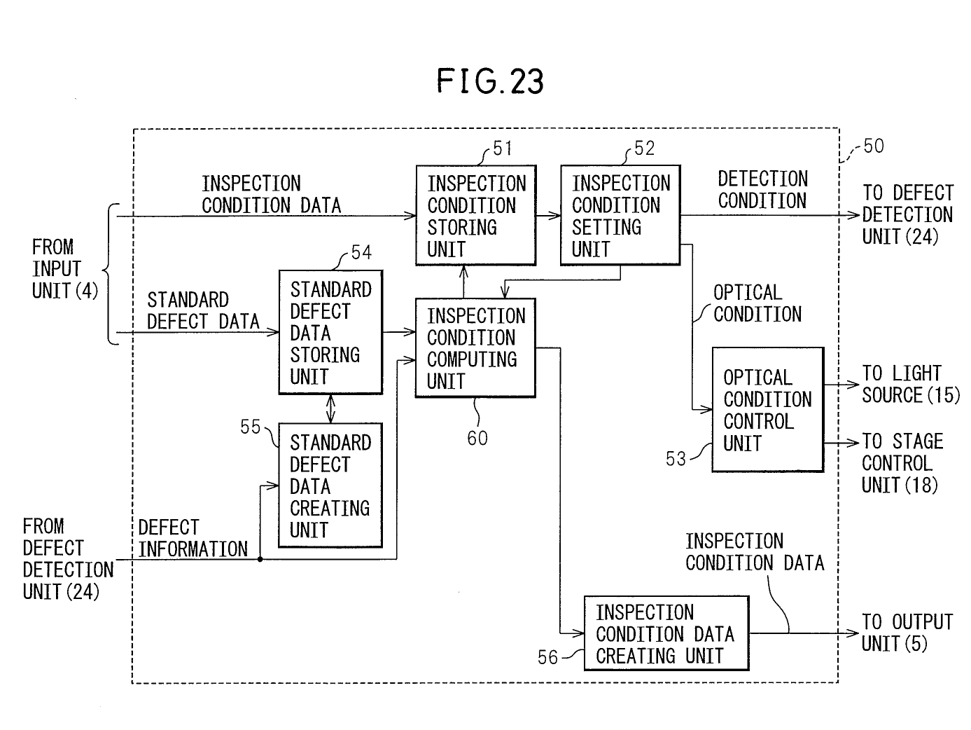

FIG. 23 is a block diagram showing a first configuration example of the inspection condition determining unit 50 shown in FIG. 20. Since the inspection condition determining unit 50 is similar in configuration to the inspection condition determining unit 50 shown in FIG. 10, the same component elements are designated by the same reference numerals, and the description of the same functions will not be repeated here. In this embodiment, the inspection condition computing unit 60 receives the defect information from the defect detection unit 24 in the image processing unit 20 shown in FIG. 22 and, based on the defect information, determines the amount of light of the light source 15 as the optical condition for the microscope unit 10 and the detection threshold value T as the detection condition for the image processing unit 20.

For the inspection condition determining unit 50 to determine the amount of light of the light source 15 and the detection threshold value T, the defect detection unit 24 outputs the defect information by including therein a predefined evaluation value representing the result of the comparison that the difference detection unit 22 made between the inspection image and the reference image, that is, between corresponding portions in the captured image that should normally be identical to each other.

Here, the value chosen as the evaluation value is such that when the evaluation value is obtained as a result of a comparison between a certain inspection image and its corresponding reference image, a determination as to whether either one of the images, the inspection image or the reference image, contains a defect can be made by comparing the evaluation value with a predetermined threshold value.

The defect detection unit 24 may include as the evaluation value in the defect information a value representing, for example, the gray level difference occurring between the inspection image and the reference image at the detected position of the defect.

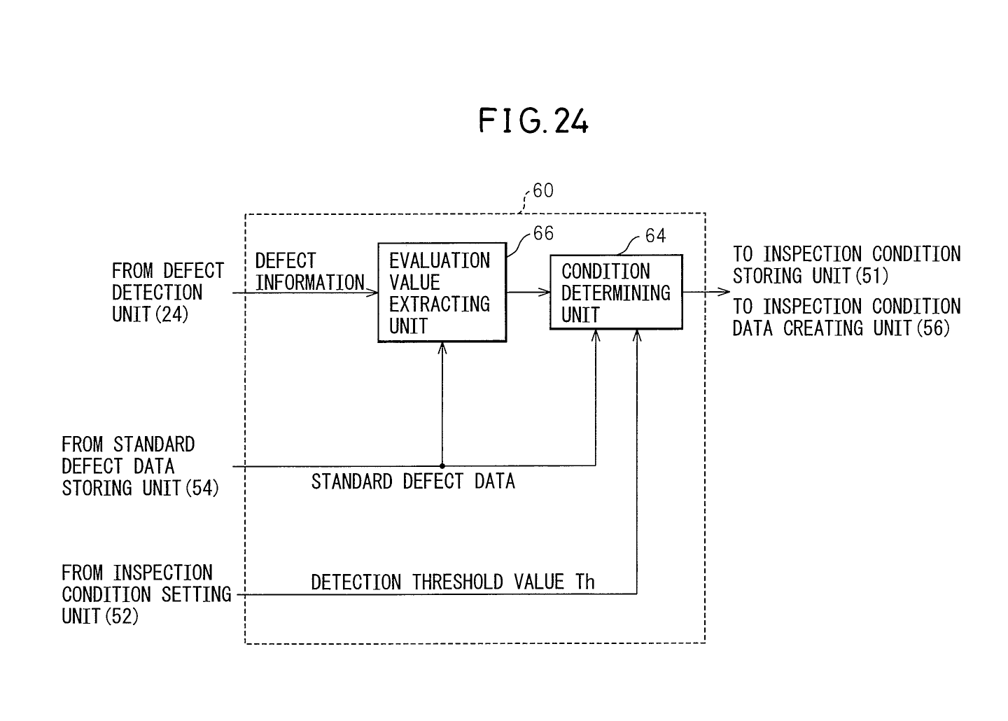

FIG. 24 is a block diagram showing a configuration example of the inspection condition computing unit 60 shown in FIG. 23. The inspection condition computing unit 60 comprises an evaluation value extracting unit 66 and a condition determining unit 64.

The evaluation value extracting unit 66 selects only the defect information concerning the standard defect from among the defect information supplied from the defect detection unit 24, and extracts the gray level difference as the evaluation value from the defect information concerning the standard defect.

Based on the evaluation value extracted by the evaluation value extracting unit 66, the condition determining unit 64 determines the amount of light of the light source 15 and the threshold value T in accordance with the following determination method.

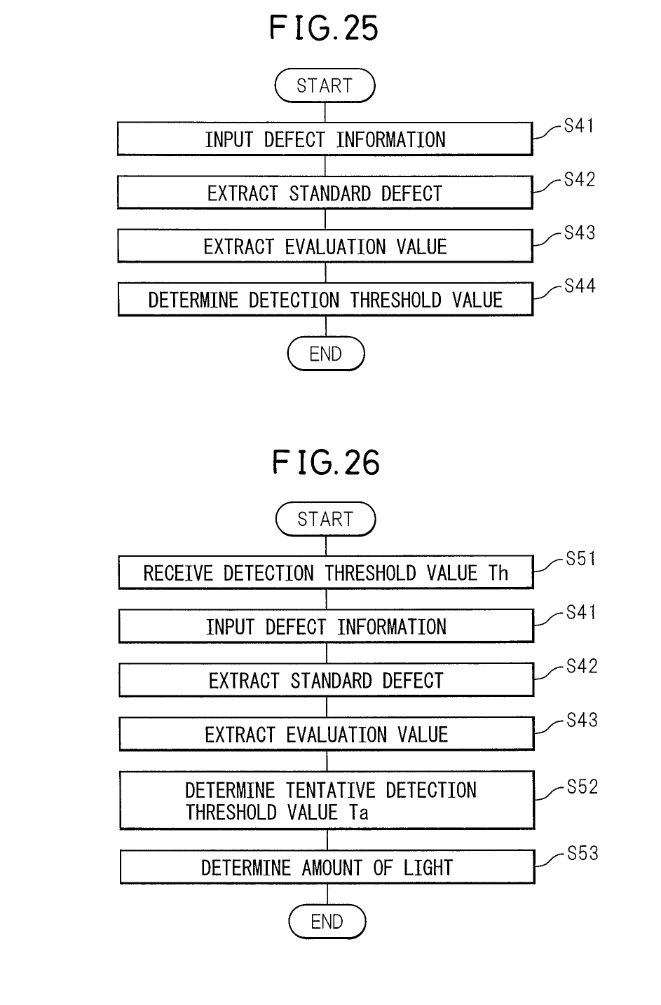

FIG. 25 is a flowchart of an inspection condition determination method according to a fourth embodiment of the present invention, showing how the inspection condition computing unit 60 shown in FIG. 23 determines the detection threshold value T.

When the defect information is input from the defect detection unit 24 to the evaluation value extracting unit 66 in step S41, the evaluation value extracting unit 66 extracts in step S42 only the defect information concerning the standard defect from among the defect information thus input. In this case, the evaluation value extracting unit 66 reads out the position information of the standard defect stored in the standard defect data storing unit 54, and extracts the defect information concerning the defect detected at the position of the standard defect thus read out.

In step S43, the evaluation value extracting unit 66 extracts the evaluation value contained in the defect information extracted in step S42. Here, the gray level difference occurring between the inspection image and the reference image at the detected position of the standard defect may be included as the evaluation value in the defect information.

In step S44, the condition determining unit 64 determines the detection threshold value T based on the evaluation value extracted by the evaluation value extracting unit 66, i.e., the gray level difference occurring at the detected position of the standard defect.

Here, when creating the defect information to be input to the evaluation value extracting unit 66, the detection threshold value to be used in the defect detection unit 24 is set a little lower to enhance the detection sensitivity of the defect detection unit 24 so that the evaluation value extracting unit 66 can extract the gray level differences for all the standard defects.

Then, the condition determining unit 64 selects the smallest one from among the gray level differences extracted by the evaluation value extracting unit 66, and determines the detection threshold value T by subtracting a prescribed margin from the smallest gray level difference. By using the thus determined detection threshold value T, every defect at least comparable in size to the standard defect can be detected without fail.

FIG. 26 is a flowchart of an inspection condition determination method according to a fifth embodiment of the present invention, showing how the inspection condition computing unit 60 shown in FIG. 23 determines the amount of light of the light source 15. In this method, as in the determination method previously described with reference to FIGS. 15 and 16, the inspection condition computing unit 60 assumes in advance the detection threshold value Th to be used, and determines the amount of light of the light source 15 that would be suitable for detecting defects with the thus assumed detection threshold value Th. For example, the inspection condition computing unit 60 determines the amount of light of the light source 15 so that when the wafer 2 is illuminated with the amount of light determined by the inspection condition computing unit 60, and defect information is generated by detecting a defect, the tentative detection threshold value Ta computed based on the defect information in the same manner as the detection threshold value T described with reference to FIG. 25 will become equal to the detection threshold value Th assumed in advance.

First, in step S51, to determine the detection threshold value Th in advance, the inspection condition computing unit 60 receives the currently used detection threshold value Th from the inspection condition setting unit 52. The detection threshold value Th thus received is input to the condition determining unit 64. In the subsequent steps S41 to S43, the evaluation value extracting unit 66 determines the evaluation value in the same manner as in S1 to S3 of the flowchart shown in FIG. 25. In step S52, the condition determining unit 64 determines the tentative detection threshold value Ta, in the same manner as the detection threshold value T determined in S44 of the flowchart shown in FIG. 25, as the detection threshold value suitable for use when detecting defects with the current amount of light, L1, of the light source 15.

Here, the evaluation value, i.e., the gray level difference occurring between the inspection image and the reference image at the detected position of the standard defect, is proportional to the amount of light of the light source 15. Accordingly, in step S53, the condition determining unit 64 calculates the target amount of light, L2, of the light source 15 from the earlier given equation (6).

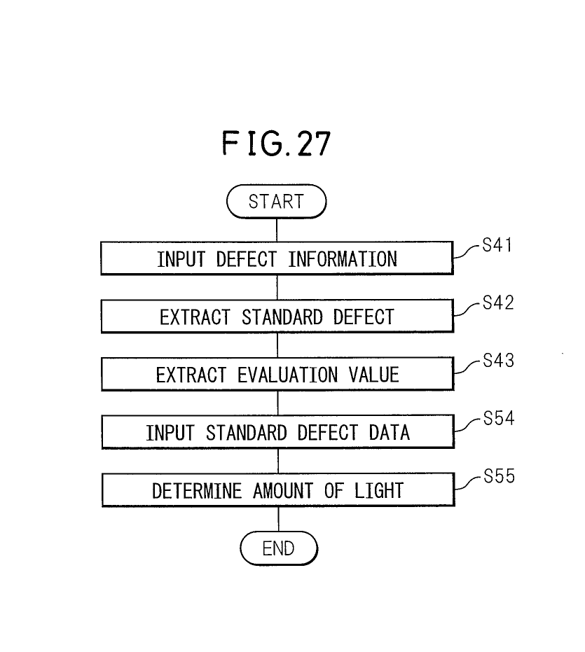

FIG. 27 is a flowchart of an inspection condition determination method according to a sixth embodiment of the present invention, showing how the inspection condition computing unit 60 shown in FIG. 23 determines the amount of light of the light source 15. In this method, the gray level difference occurring between the inspection image and the reference image at the detected position of the standard defect when the wafer 2 is illuminated with a suitable amount of light is determined in advance as the target evaluation value through measurement or simulation. Then, as in the method described with reference to FIG. 25, the amount of light of the light source 15 is determined so that the evaluation value extracted from the defect information becomes equal to the target evaluation value.

For this purpose, the target evaluation value, that is, in this example, the gray level difference occurring between the inspection image and the reference image at the detected position of the standard defect when the wafer 2 is illuminated with a suitable amount of light, is stored in the standard defect data storing unit 54 shown in FIG. 23 as standard defect data. This target evaluation value may be externally supplied to the inspection condition setting unit 50 via the data input unit 4, or may be computed in the image processing unit 20 by using the image captured by the microscope unit 10 in the surface inspection apparatus 1. The inspection condition setting unit 50 shown in FIG. 23 includes a standard defect data creating unit 55 which receives the defect information output from the defect detection unit 24 shown in FIG. 22, and creates standard defect data containing the target evaluation value.

When creating the standard defect data that contains the target evaluation value as the gray level difference occurring between the inspection image and the reference image at the detected position of the standard defect when the wafer 2 is illuminated with a suitable amount of light, first the defect detection is performed several times by changing the inspection conditions, and the surface inspection apparatus 1 is set in a condition that can accurately detect the standard defect. Then, in this condition, the defect information output from the defect detection unit 24 shown in FIG. 22 is input to the standard defect data creating unit 55.

Based on the position information of the standard defect stored in the standard defect data storing unit 54, the standard defect data creating unit 55 extracts the defect information concerning the standard defect from among the defect information thus input.

As described above, the defect information output from the defect detection unit 24 contains the gray level difference detected between the inspection image and the reference image at the position of the detected defect. The standard defect data creating unit 55 acquires from the extracted defect information of the standard defect the gray level difference detected between the inspection image and the reference image at the position of the standard defect, and stores it in the standard defect data storing unit 53 as the standard defect data concerning the detected standard defect.

Turning back to FIG. 27, in steps S41 to S43, as in S1 to S3 of the flowchart shown in FIG. 25, the evaluation value extracting unit 66 determines as the evaluation value to be included in the defect information the gray level difference ΔGLs occurring between the inspection image and the reference image at the detected position of the standard defect.

In step S54, from the standard defect data storing unit 54, the gray level difference ΔGLt occurring between the inspection image and the reference image at the detected position of the standard defect when the wafer 2 is illuminated with a suitable amount of light is input as the target evaluation value to the condition determining unit 64.

In step S55, the condition determining unit 64 determines the amount of light, L2, of the light source 15 based on the evaluation value ΔGLs contained in the defect information and on the target evaluation value ΔGLt. Here, since the gray level difference between the inspection image and the reference image is proportional to the amount of light, the amount of light, L2, can be calculated from the following equation.

L2=L1×ΔGLt/ΔGLs (7)

### In the above equation (7), L1 indicates the amount of light of the light source 15 when the defect information input in step S41 is detected.

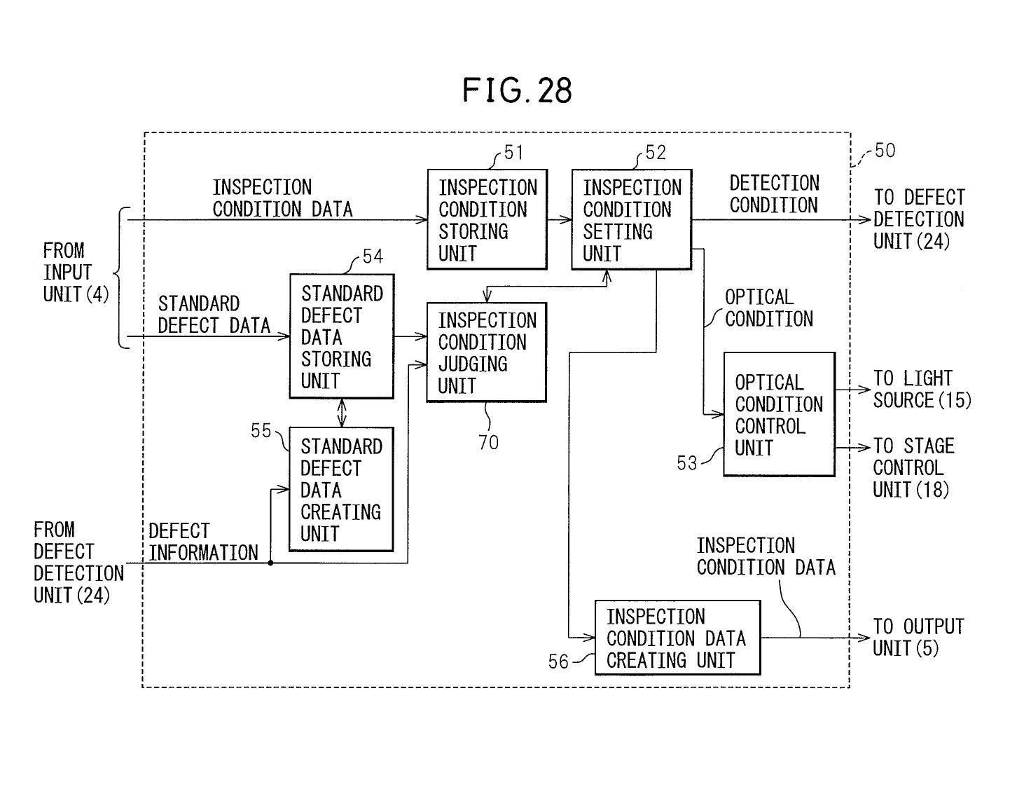

FIG. 28 is a block diagram showing a second configuration example of the inspection condition determining unit 50 shown in FIG. 20. Since the inspection condition determining unit 50 shown in FIG. 28 is similar in configuration to the inspection condition determining unit 50 shown in FIG. 23, similar component elements are designated by like reference numerals, and the description of the same functions that the similar component elements are supposed to have will not be repeated here.

In this example, the inspection condition determining unit 50 includes an inspection condition judging unit 70. The inspection condition judging unit 70 judges whether, in the image captured under given optical conditions defining the amount of light of the light source 15 of the microscope unit 10, the focusing condition of the microscope unit 10, etc., the detection result DR of the standard defect detected by the defect detection unit 24 shown in FIG. 22 matches a predetermined detection target value DT.

Here, the number of standard defects detected when a prescribed region on the wafer 2 was inspected for defects, for example, may be used as the standard defect detection result DR.

For the inspection condition judging unit 70 to judge whether the detection result DR matches the detection target value DT, the number of standard defects provided in the prescribed region may be stored as the detection target value DT in the standard defect data storing unit 54. The number of standard defects to be stored in the standard defect data storing unit 54 may be externally supplied via the data input unit 4.

Alternatively, the defect size of the standard defect may be used as the standard defect detection result DR and the detection target value DT. Information concerning the standard defect size to be stored in the standard defect data storing unit 54 may be externally supplied via the data input unit 4. If the defect detection unit 24 shown in FIG. 22 has the function of determining the size of the detected defect and outputting the defect information by including the defect size therein, information concerning the standard defect size may be created in the standard defect data creating unit 55 based on the defect information, and the thus created information may be stored in the standard defect data storing unit 54.

When creating the standard defect size information in the standard defect data creating unit 55, first the defect detection is performed several times by changing the inspection conditions, and the surface inspection apparatus 1 is set in a condition that can accurately detect the standard defect. Then, in this condition, the defect information output from the defect detection unit 24 shown in FIG. 22 is input to the standard defect data creating unit 55. Based on the position information of the standard defect stored in the standard defect data storing unit 54, the standard defect data creating unit 55 extracts the defect information concerning the standard defect from among the defect information thus input.

The standard defect data creating unit 55 acquires the defect size of the standard defect included in the extracted defect information of the standard defect, and stores it in the standard defect data storing unit 53 as the standard defect data concerning the detected standard defect.

While the image capturing unit 14 is repeatedly capturing images of the surface of the wafer 2, the inspection condition setting unit 52 changes at least one of the inspection conditions. As earlier described, the action of the image capturing unit 14 meant by the phrase “repeatedly capturing images” not only includes, for example, capturing an image of the same wafer 2 a plurality of times, but also includes capturing respective images of different wafers 2 on which similar standard defects are formed. In particular, when performing surface inspection by sequentially changing wafers, “repeatedly capturing images” also includes the action of capturing an image of each wafer 2 at least once while the different wafers 2 are loaded into the surface inspection apparatus 1 one after another. It also includes the action of capturing images of different regions of the same wafer 2 at different times in a single sequence of image capturing operations.

When the inspection condition setting unit 52 changes the optical condition while the image capturing unit 14 is repeatedly capturing images of the surface of the wafer 2, the inspection condition judging unit 70 takes as an input the defect information generated for each image captured under the optical condition changed by the inspection condition setting unit 52, and judges whether the detection result DR relating to the thus captured image matches the given detection target value DT.

On the other hand, when the inspection condition setting unit 52 changes the detection condition while the image capturing unit 14 is repeatedly capturing images of the surface of the wafer 2, the inspection condition judging unit 70 takes as inputs the defect information relating to each defect detected on the captured image received from the image capturing unit 14 using the detection condition changed by the inspection condition setting unit 52, and judges whether the detection result DR relating to the thus captured image matches the given detection target value DT.

When the detection result DR obtained from the defect information is judged to match the given detection target value DT, the inspection condition judging unit 70 outputs an inspection condition change stopping signal instructing the inspection condition setting unit 52 to stop changing the inspection condition. As a result, the inspection condition is set to a condition under which the standard defect formed on the wafer 2 can be detected.

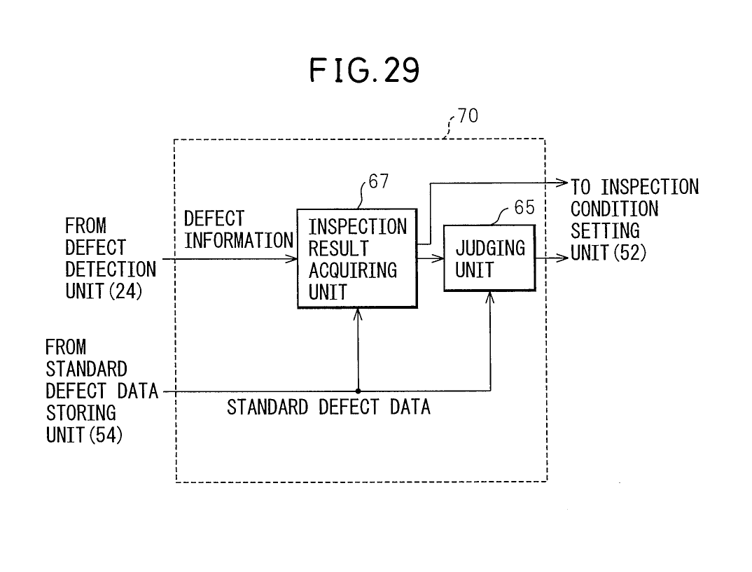

FIG. 29 is a block diagram showing a configuration example of the inspection condition judging unit 70 shown in FIG. 28. The inspection condition judging unit 70 comprises a detection result acquiring unit 67 and a judging unit 65.

Based on the defect information supplied to the inspection condition judging unit 70 from the defect detection unit 24 shown in FIG. 22, the detection result acquiring unit 67 acquires the detection result DR described above, that is, the number of standard defects detected within the prescribed region or the size of the detected standard defect.

The judging unit 65 judges whether the detection result DR acquired by the detection result acquiring unit 67 matches the detection target value DT prestored in the standard defect data storing unit 54. If the detection result DR matches the detection target value DT, the inspection condition change stopping signal is supplied to the inspection condition setting unit 52.

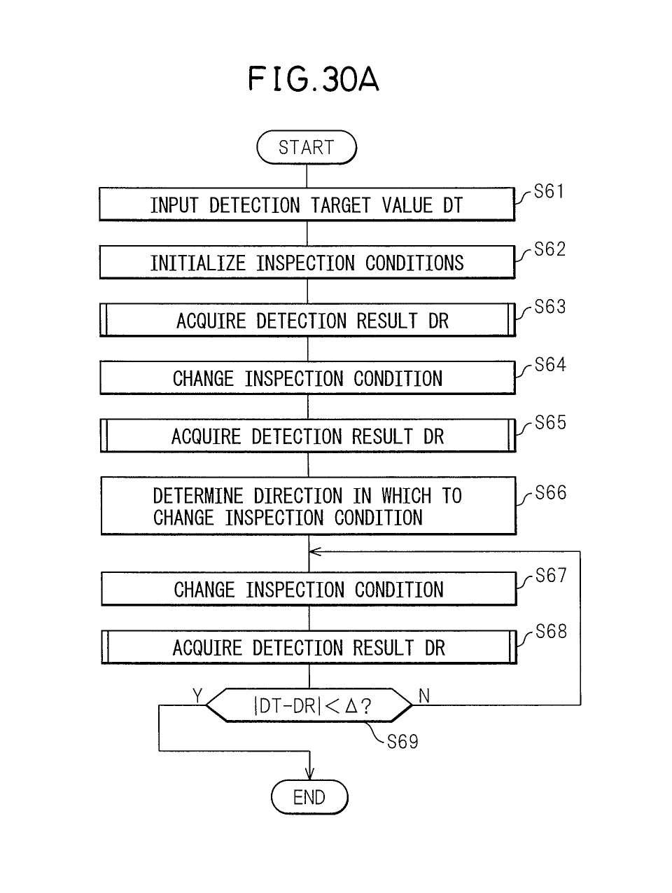

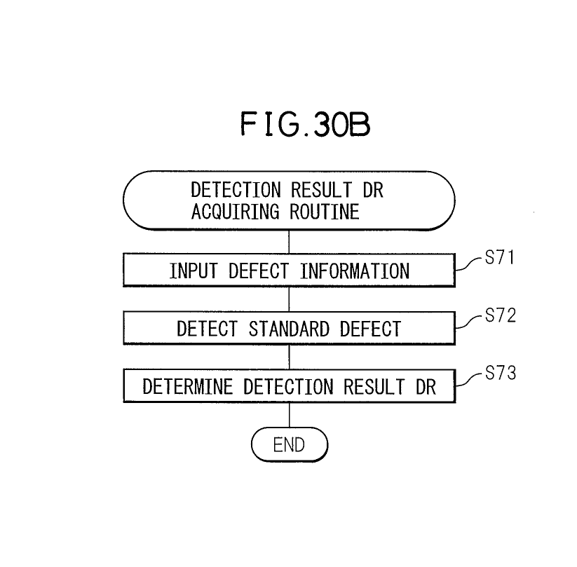

FIG. 30A is a flowchart of an inspection condition determination method according to a seventh embodiment of the present invention.

In step S61, the detection target value DT included in the standard defect data stored in the standard defect data storing unit 54 is input to the judging unit 65.

In step S62, the inspection condition setting unit 52 initializes the inspection conditions, i.e., the optical conditions for the microscope unit 10 and the detection threshold value Th for the image processing unit 20, to predetermined states. Here, the initialization of the inspection conditions in step S62 is not mandatory, and the process may proceed directly to step S63 while using the current inspection conditions.

When the defect inspection is performed by the surface inspection apparatus 1 with the inspection conditions set in step S62, the resulting defect information is input to the inspection condition judging unit 70. In step S63, the inspection condition judging unit 70 acquires the detection result DR based on the defect information thus input. FIG. 30B is a flowchart of a detection result acquiring routine called from the flowchart of FIG. 30A.

In step S71, the detection result acquiring unit 67 acquires the defect information from the defect detection unit 24 shown in FIG. 22, and in step S72, it extracts only the defect information relating to the standard defect contained in the acquired defect information. In this case, the detection result acquiring unit 67 reads out the position information of the standard defect stored in the standard defect data storing unit 54, and extracts the defect information concerning the defect detected at the position of the standard defect thus read out. Then, in step S73, the detection result acquiring unit 67 determines the detection result DR based on the thus extracted defect information of the standard defect.

For example, when using the number of standard defects detected in the prescribed region on the wafer as the detection result DR, the detection result acquiring unit 67 determines the detection result DR by counting the number of pieces of information relating to the standard defects detected in the prescribed region.

On the other hand, when using the defect size of the standard defect as the detection result DR, the detection result acquiring unit 67 extracts the defect size of the standard defect included in the extracted defect information of the standard defect.

The inspection condition judging unit 70 supplies the thus acquired detection result DR to the inspection condition setting unit 52 which temporarily stores it in a storage means not shown.

Turning back to FIG. 30A, in step S64 the inspection condition setting unit 52 changes at least one of the inspection conditions. In step S65 after changing the inspection condition, the inspection condition judging unit 70 acquires the detection result DR and supplies it to the inspection condition setting unit 52.

In step S66, the inspection condition setting unit 52 determines the direction in which the inspection condition is to be changed, by checking which of the two detection results DR, one acquired in step S63 and the other acquired in step S65, is closer to the detection target value DT.

For example, if the detection result DR acquired in step S65 is closer to the detection target value DT than the detection result DR acquired in step S63 is, the inspection condition setting unit 52 determines that the inspection condition should be changed in the subsequent step (S67) in the same direction in which it was changed in step S64.

Conversely, if the detection result DR acquired in step S63 is closer to the detection target value DT than the detection result DR acquired in step S65 is, the inspection condition setting unit 52 determines that the inspection condition should be changed in the subsequent step in the direction opposite to the direction in which it was changed in step S64.

Then, in step S67, the inspection condition setting unit 52 changes the inspection condition in the direction determined in step S66. In step S68, the inspection condition judging unit 70 acquires the detection result DR.

In step S69, the inspection condition judging unit 70 judges whether the difference between the detection result DR and the detection target value DT is smaller than a predetermined value Δ, and if the difference between DR and DT (|DT−DR|) is smaller than the predetermined value Δ, the inspection condition judging unit 70 outputs the inspection condition change stopping signal to the inspection condition setting unit 52 to stop changing the inspection condition; otherwise, the process returns to step S67 to repeat the steps S67 to S69.

The above embodiments of the present invention have been described by dealing with a surface inspection apparatus that detects defects appearing in an image captured of the surface of a sample by an optical image capturing means that uses illumination light. However, the present invention is not limited to this particular type of apparatus, but can also be applied to a surface inspection apparatus that detects defects appearing in an image captured of the surface of a sample by an electro-optic image capturing means such as a scanning electron microscope (SEM) that uses an electron beam.

In that case, the inspection condition determining unit 50 shown in FIG. 5 or 20 may be used to determine the electro-optic conditions to be used in the electro-optic image capturing means, such as electron beam current, voltage to be applied to the electron gun, astigmatism adjustment of the electron beam, focusing condition, etc., in the same manner that it is used to correct the optical conditions of the microscope unit 10.

Likewise, the inspection condition determining unit 50 may be used to determine the defect detection conditions used when detecting defects appearing in an electron beam image obtained by the electro-optic image capturing means.

Accordingly, the terms “optical system” and its “optical condition” as used in the appended claims refer not only to an optical system that handles light as a form of electromagnetic wave and the optical condition for the optical system, but also to an electro-optic system that handles an electron beam and the setup condition for the electro-optic system.

According to the present invention, the inspection conditions such as the optical conditions and defect detection conditions to be used in the surface inspection apparatus and the surface inspection method can be set properly in accordance with the actual sample to be inspected.

The present invention is applicable to a surface inspection apparatus and surface inspection method for detecting a defect on the surface of a sample under inspection by inspecting an image captured of the surface of the sample. More particularly, the invention is applicable to a surface inspection apparatus and surface inspection method for detecting a defect in a pattern formed on the surface of a substrate such as a semiconductor wafer, a photomask substrate, a liquid crystal display panel substrate, or a liquid crystal device substrate, based on an image captured of the surface of the substrate.

While the invention has been described with reference to specific embodiments chosen for purpose of illustration, it should be apparent that numerous modifications could be made thereto by those skilled in the art without departing from the basic concept and scope of the invention.

What is claimed is:

1. A surface inspection apparatus for detecting a defect on a surface of a sample by inspecting an image captured of the surface of said sample under a prescribed optical condition, comprising:
a defect detection unit for detecting a defect appearing in said image by using a prescribed detection condition; and
an inspection condition determining unit for setting at least one of said prescribed optical condition and said prescribed detection condition to a condition under which a known standard defect formed in advance on an inspection surface of said sample to be inspected can be detected by said defect detection unit.

2. A surface inspection apparatus as claimed in claim 1, wherein said defect detection unit is configured so that when, in the image captured of the surface of said sample, a gray level difference detected between corresponding portions that should normally be identical to each other satisfies said prescribed detection condition, said corresponding portions are detected as defect candidates, and
said inspection condition determining unit is configured to set at least one of said prescribed optical condition and said prescribed detection condition to a condition such that, in the image captured of the surface of said sample under said prescribed optical condition and with said standard defect formed thereon, a standard defect gray level difference, which is a gray level difference occurring between a portion containing said standard defect and a portion corresponding thereto, can satisfy said prescribed detection condition.

3. A surface inspection apparatus as claimed in claim 2, wherein said inspection condition determining unit determines said prescribed detection condition based on said standard defect gray level difference.

4. A surface inspection apparatus as claimed in claim 2, further comprising: an illuminating unit for illuminating the surface of said sample with a prescribed amount of light that is set as said prescribed optical condition; and an image capturing unit for capturing the image of the surface of said sample illuminated with said illuminating unit, and wherein
said inspection condition determining unit is configured to determine said prescribed amount of light in accordance with a prescribed determination method, based on said prescribed detection condition and on said standard defect gray level difference detected in the image captured of said sample containing said standard defect by said image capturing unit.

5. A surface inspection apparatus as claimed in claim 2, further comprising: an illuminating unit for illuminating the surface of said sample with prescribed illumination light; and an image capturing unit for capturing the image of the surface of said sample illuminated with said illuminating unit, and wherein
said inspection condition determining unit is configured to determine at least one of said prescribed optical condition and said prescribed detection condition by successively changing said at least one condition while said image capturing unit repeatedly captures images of said sample with said standard defect formed thereon, until said standard defect gray level difference satisfies said prescribed detection condition.

6. A surface inspection apparatus as claimed in claim 5, wherein said optical condition determined by said inspection condition determining unit is the amount of light of said illuminating unit.

7. A surface inspection apparatus as claimed in claim 5, wherein said optical condition determined by said inspection condition determining unit is a focusing condition of said image capturing unit.

8. A surface inspection apparatus as claimed in claim 1, wherein said defect detection unit is configured so that when, in the image captured of the surface of said sample, a comparison result obtained as a result of a comparison between corresponding portions that should normally be identical to each other satisfies said prescribed detection condition, said corresponding portions are detected as defect candidates, and prescribed defect information is output for each of said detected defect candidates,
said prescribed defect information contains a prescribed evaluation value indicating the result of the comparison made between said corresponding portions, said evaluation value being such that by comparing said evaluation value with a predetermined threshold value, it can be determined whether each of said corresponding portions is a defect candidate or not, and
said inspection condition determining unit is configured to determine at least one of said prescribed optical condition and said prescribed detection condition in accordance with a prescribed determination method, based on said prescribed evaluation value contained in said defect information that said defect detection unit output for said standard defect.

9. A surface inspection apparatus as claimed in claim 8, wherein said prescribed evaluation value indicates the gray level difference detected between said corresponding portions either one of which contains said standard defect, and
said inspection condition determining unit is configured to determine said prescribed detection condition based on said gray level difference.

10. A surface inspection apparatus as claimed in claim 8, further comprising: an illuminating unit for illuminating the surface of said sample with a prescribed amount of light that is set as said prescribed optical condition; and an image capturing unit for capturing the image of the surface of said sample illuminated with said illuminating unit, and wherein
said prescribed evaluation value indicates the gray level difference detected between said corresponding portions either one of which contains said standard defect, in the image captured of said sample containing said standard defect by said image capturing unit, and
said inspection condition determining unit is configured to determine said prescribed amount of light in accordance with a prescribed determination method, based on said gray level difference and said prescribed detection condition.

11. A surface inspection apparatus as claimed in claim 1, wherein said defect detection unit is configured so that when, in the image captured of the surface of said sample, a comparison result obtained as a result of a comparison between corresponding portions that should normally be identical to each other satisfies said prescribed detection condition, said corresponding portions are detected as defect candidates, and
said inspection condition determining unit is configured to determine at least one of said prescribed optical condition and said prescribed detection condition by successively changing said at least one condition while said defect detection unit repeatedly detects said standard defect, until a detection result of said standard defect matches a prescribed target condition.

12. A surface inspection apparatus as claimed in claim 11, further comprising: an illuminating unit for illuminating the surface of said sample; and an image capturing unit for capturing the image of the surface of said sample illuminated with said illuminating unit, and wherein
said optical condition determined by said inspection condition determining unit is the amount of light of said illuminating unit.

13. A surface inspection apparatus as claimed in claim 11, further comprising an image capturing unit for capturing the image of the surface of said sample, and wherein
said optical condition determined by said inspection condition determining unit is a focusing condition of said image capturing unit.

14. A surface inspection method for detecting a defect on a surface of a sample by inspecting an image captured of the surface of said sample under a prescribed optical condition, comprising:
a defect detection step for detecting a defect appearing in said image by using a prescribed detection condition; and
an inspection condition determining step for setting at least one of said prescribed optical condition and said prescribed detection condition to a condition under which a known standard defect formed in advance on an inspection surface of said sample to be inspected can be detected in said defect detection step.

15. A surface inspection method as claimed in claim 14, wherein when, in the image captured of the surface of said sample, a gray level difference detected between corresponding portions that should normally be identical to each other satisfies said prescribed detection condition, said defect detection step detects said corresponding portions as defect candidates, and
said inspection condition determining step sets at least one of said prescribed optical condition and said prescribed detection condition to a condition such that, in the image captured of the surface of said sample under said prescribed optical condition and with said standard defect formed thereon, a standard defect gray level difference, which is a gray level difference occurring between a portion containing said standard defect and a portion corresponding thereto, can satisfy said prescribed detection condition.

16. A surface inspection method as claimed in claim 15, wherein said inspection condition determining step determines said prescribed detection condition based on said standard defect gray level difference.

17. A surface inspection method as claimed in claim 15, further comprising an image capturing step for illuminating the surface of said sample with a prescribed amount of light that is set as said prescribed optical condition, and thereby capturing the image of the surface of said sample on which a defect, if any, is to be detected in said defect detection step, and wherein
said inspection condition determining step determines said prescribed amount of light in accordance with a prescribed determination method, based on said prescribed detection condition and on said standard defect gray level difference detected in said image capturing step in the image captured of said sample containing said standard defect.

18. A surface inspection method as claimed in claim 15, further comprising an image capturing step for illuminating the surface of said sample with prescribed illumination light and thereby capturing the image of the surface of said sample on which a defect, if any, is to be detected in said defect detection step, and wherein
said inspection condition determining step determines at least one of said prescribed optical condition and said prescribed detection condition by successively changing said at least one condition while said image capturing step is repeatedly carried out, until said standard defect gray level difference satisfies said prescribed detection condition.

19. A surface inspection method as claimed in claim 18, wherein said optical condition determined by said inspection condition determining step is the amount of said illumination light.

20. A surface inspection method as claimed in claim 18, wherein said optical condition determined by said inspection condition determining step is a focusing condition of an image capturing unit used in said image capturing step.

21. A surface inspection method as claimed in claim 14, wherein when, in the image captured of the surface of said sample, a comparison result obtained as a result of a comparison between corresponding portions that should normally be identical to each other satisfies said prescribed detection condition, said defect detection step detects said corresponding portions as defect candidates, and creates prescribed defect information for each of said detected defect candidates,
said prescribed defect information contains a prescribed evaluation value indicating the result of the comparison made between said corresponding portions, said evaluation value being such that by comparing said evaluation value with a predetermined threshold value, it can be determined whether each of said corresponding portions is a defect candidate or not, and
said inspection condition determining step determines at least one of said prescribed optical condition and said prescribed detection condition in accordance with a prescribed determination method, based on said prescribed evaluation value contained in said defect information created in said defect detection step for said standard defect.

22. A surface inspection method as claimed in claim 21, wherein said prescribed evaluation value indicates the gray level difference detected between said corresponding portions either one of which contains said standard defect, and
said inspection condition determining step determines said prescribed detection condition based on said gray level difference.

23. A surface inspection method as claimed in claim 21, further comprising an image capturing step for illuminating the surface of said sample with a prescribed amount of light that is set as said prescribed optical condition, and thereby capturing the image of the surface of said sample on which a defect, if any, is to be detected in said defect detection step, and wherein said prescribed evaluation value indicates the gray level difference detected between said corresponding portions either one of which contains said standard defect, in the image captured in said image capturing step from said sample with said standard defect formed thereon, and
said inspection condition determining step determines said prescribed amount of light in accordance with a prescribed determination method, based on said gray level difference and said prescribed detection condition.

24. A surface inspection method as claimed in claim 14, wherein when, in the image captured of the surface of said sample, a comparison result obtained as a result of a comparison between corresponding portions that should normally be identical to each other satisfies said prescribed detection condition, said defect detection step detects said corresponding portions as defect candidates, and
said inspection condition determining step determines at least one of said prescribed optical condition and said prescribed detection condition by successively changing said at least one condition while said defect detection step is repeatedly carried out, until a detection result obtained by detecting said standard defect in said defect detection step matches a prescribed target condition.

25. A surface inspection method as claimed in claim 24, further comprising an image capturing step for illuminating the surface of said sample with prescribed illumination light and thereby capturing the image of the surface of said sample on which a defect, if any, is to be detected in said defect detection step, and wherein
said optical condition determined in said inspection condition determining step is the amount of light of said illumination light.

26. A surface inspection method as claimed in claim 24, further comprising an image capturing step for capturing the image of the surface of said sample on which a defect, if any, is to be detected in said defect detection step, and wherein
said optical condition determined in said inspection condition determining step is a focusing condition of an image capturing unit used in said image capturing step.
